(19) United States
(12) Patent Application Publication
(10) Pub. No.: US 2026/0361357 A1
(43) Pub. Date: Nov. 12, 2026

(54) BEAM WEIGHT TRANSFER FROM A DISTRIBUTED UNIT (DU) TO A RADIO UNIT (RU)

(71) Applicant: QUALCOMM Incorporated, San Diego, CA (US)

(72) Inventors: Ashmeet Kaur CHANDOK, Thornhill (CA); Christian Oliver THELEN, Palm Desert, CA (US); Gagan KUMAR, San Marcos, CA (US); Abhishek Saurabh SACHIDANAND SINHA, San Diego, CA (US); Deepak AGARWAL, San Diego, CA (US)

(21) Appl. No.: 19/660,001

(22) Filed: Apr. 27, 2026

Related U.S. Application Data
(60) Provisional application No. 63/802,223, filed on May 8, 2025.

(51) Int. Cl. H04B 7/06; H04L 5/00

(52) U.S. Cl. CPC H04B 7/0617; H04L 5/0053

(57) ABSTRACT

This disclosure provides methods, components, devices, and systems for beam weight transfer. For example, the DU may transmit, for the RU, a first message that indicates respective sets of beam weight parameters for a set of communication beams at the RU. In some examples, the first message may include a section with a section type X associated with updating beam weights. In some other examples, the first message may include a section with a section type 4 and a command type associated with updating beam weights. The first message may additionally indicate an acknowledgment request identifier (ID). The RU may receive the first message and may update a codebook to reflect the indicated beam weight parameters. The RU may transmit an acknowledgment message to the DU that indicates successful application of the beam weight updates at the RU.

### CROSS REFERENCE

This Patent application claims the benefit of U.S. Provisional Patent Application No. 63/802,223 by CHANDOK et al., entitled “BEAM WEIGHT TRANSFER FROM A DISTRIBUTED UNIT (DU) TO A RADIO UNIT (RU),” filed May 8, 2025, assigned to the assignee hereof, and expressly incorporated herein.

### TECHNICAL FIELD

This disclosure relates generally to wireless communication and more specifically to systems, devices, methods, and techniques associated with beam weight transfer from a distributed unit (DU) to a radio unit (RU).

### DESCRIPTION OF THE RELATED TECHNOLOGY

Communication systems are deployed to provide communication services such as voice, video, packet data, messaging, or broadcast, among others. A communication system may include a wireless communication network (such as a radio access network (RAN)) that supports communication between wireless communication devices such as network entities (such as base stations), client devices (such as one or more user equipments (UEs)), and others. Such devices may communicate with one another using a variety of protocols (such as radio access technologies (RATs)), including those of cellular-based systems such as fourth generation (4G) systems (such as Long Term Evolution (LTE) systems), fifth generation (5G) systems (such as 5G New Radio (5G-NR) systems), and sixth generation (6G) systems. A wireless communication network may support communication by implementing system resources (such as frequency resources, time resources, spatial resources) in accordance with a wireless communication protocol.

In some wireless communication systems, such as an open RAN (O-RAN) system, a first network entity (e.g., a distributed unit (DU)) may control beam weight parameters for a second network entity (e.g., a radio unit (RU)). For example, the DU may determine, for a communication beam corresponding to a specific beam identifier (ID), a set of beam weight parameters (e.g., beamforming weight values) for a set of antennas at the RU to form the communication beam. The DU may transmit an indication of the beam weight parameters to the RU to perform a beam weight update. However, in some cases, the message indicating the beam weight parameters may involve significant signaling overhead based on the message including other fields that are irrelevant to the beam weight update. Additionally, or alternatively, the DU may fail to determine whether the RU completed the beam weight update, reducing coordination between the DU and RU and potentially resulting in inefficient or incorrect beamforming operations at the RU.

### SUMMARY

The systems, methods, and devices of this disclosure each have several innovative aspects, no single one of which is solely responsible for the desirable attributes disclosed herein. The following is a summary of some non-limiting aspects of the disclosure:

A first network entity for wireless communication is described. The first network entity may include a processing system that includes processor circuitry and memory circuitry that stores code. The processing system may be configured to cause the first network entity to output, for a radio unit (RU), a first message that includes a payload indicating respective sets of beam weight parameters for a set of communication beams and an acknowledgment request identifier and obtain a second message that indicates successful or unsuccessful application of the respective sets of beam weight parameters for the set of communication beams at the RU based on the acknowledgment request identifier.

A method for wireless communication at a first network entity is described. The method may include outputting, for an RU, a first message that includes a payload indicating respective sets of beam weight parameters for a set of communication beams and an acknowledgment request identifier and obtaining a second message that indicates successful or unsuccessful application of the respective sets of beam weight parameters for the set of communication beams at the RU based on the acknowledgment request identifier.

Another first network entity for wireless communication is described. The first network entity may include means for outputting, for an RU, a first message that includes a payload indicating respective sets of beam weight parameters for a set of communication beams and an acknowledgment request identifier and means for obtaining a second message that indicates successful or unsuccessful application of the respective sets of beam weight parameters for the set of communication beams at the RU based on the acknowledgment request identifier.

A non-transitory computer-readable medium storing code for wireless communication at a first network entity is described. The code may include instructions executable by one or more processors to output, for an RU, a first message that includes a payload indicating respective sets of beam weight parameters for a set of communication beams and an acknowledgment request identifier and obtain a second message that indicates successful or unsuccessful application of the respective sets of beam weight parameters for the set of communication beams at the RU based on the acknowledgment request identifier.

Some examples of the method, first network entities, and non-transitory computer-readable medium described herein may further include operations, features, means, or instructions for outputting, for the RU, a retransmission of the first message based on the second message indicating the unsuccessful application of the respective sets of beam weight parameters for the set of communication beams at the RU.

In some examples of the method, first network entities, and non-transitory computer-readable medium described herein, the first message includes a common header field that indicates a section type value associated with a beam weight update, and the payload of the first message may be based on the section type value being associated with the beam weight update.

In some other examples of the method, first network entities, and non-transitory computer-readable medium described herein, the first message includes a common header field that indicates a section type value of 4 associated with a slot level configuration and a section type 4 command type field that indicates a beam weight update, and the payload of the first message may be based on the section type value of 4 being associated with the slot level configuration and the section type 4 command type field indicating the beam weight update.

In some examples of the method, first network entities, and non-transitory computer-readable medium described herein, the RU may be associated with an open radio access network (O-RAN) system, and the first network entity may include a distributed unit (DU) associated with the O-RAN system.

A second network entity for wireless communication is described. The second network entity may include a processing system that includes processor circuitry and memory circuitry that stores code. The processing system may be configured to cause the second network entity to obtain a first message that includes a payload indicating respective sets of beam weight parameters for a set of communication beams and an acknowledgment request identifier and output, for a DU, a second message that indicates successful or unsuccessful application of the respective sets of beam weight parameters for the set of communication beams at the second network entity based on the acknowledgment request identifier.

Another method for wireless communication at a second network entity is described. The method may include obtaining a first message that includes a payload indicating respective sets of beam weight parameters for a set of communication beams and an acknowledgment request identifier and outputting, for a DU, a second message that indicates successful or unsuccessful application of the respective sets of beam weight parameters for the set of communication beams at the second network entity based on the acknowledgment request identifier.

Another second network entity for wireless communication is described. The second network entity may include means for obtaining a first message that includes a payload indicating respective sets of beam weight parameters for a set of communication beams and an acknowledgment request identifier and means for outputting, for a DU, a second message that indicates successful or unsuccessful application of the respective sets of beam weight parameters for the set of communication beams at the second network entity based on the acknowledgment request identifier.

A non-transitory computer-readable medium storing code for wireless communication is described. The code may include instructions executable by one or more processors to obtain a first message that includes a payload indicating respective sets of beam weight parameters for a set of communication beams and an acknowledgment request identifier and output, for a DU, a second message that indicates successful or unsuccessful application of the respective sets of beam weight parameters for the set of communication beams at the second network entity based on the acknowledgment request identifier.

Some examples of the method, second network entities, and non-transitory computer-readable medium described herein may further include operations, features, means, or instructions for updating a codebook of beam weights based on the respective sets of beam weight parameters for the set of communication beams, where the second message indicates the successful application of the respective sets of beam weight parameters for the set of communication beams at the second network entity based on the updating the codebook.

Some other examples of the method, second network entities, and non-transitory computer-readable medium described herein may further include operations, features, means, or instructions for refraining from updating a codebook of beam weights based on the respective sets of beam weight parameters for the set of communication beams, where the second message indicates the unsuccessful application of the respective sets of beam weight parameters for the set of communication beams at the second network entity based on the refraining from updating the codebook, and obtaining a retransmission of the first message based on the second message indicating the unsuccessful application of the respective sets of beam weight parameters for the set of communication beams at the second network entity.

In some examples of the method, second network entities, and non-transitory computer-readable medium described herein, the first message includes a common header field that indicates a section type value associated with a beam weight update, and the payload of the first message may be based on the section type value being associated with the beam weight update.

In some other examples of the method, second network entities, and non-transitory computer-readable medium described herein, the first message includes a common header field that indicates a section type value of 4 associated with a slot level configuration and a section type 4 command type field that indicates a beam weight update, and the payload of the first message may be based on the section type value of 4 being associated with the slot level configuration and the section type 4 command type field indicating the beam weight update.

In some examples of the method, second network entities, and non-transitory computer-readable medium described herein, the DU may be associated with an O-RAN system and the second network entity may include an RU associated with the O-RAN system.

### BRIEF DESCRIPTION OF THE DRAWINGS

FIG. 1 shows an example of a wireless communication system.

FIG. 2 shows an example of a signaling configuration that supports beam weight transfer from a distributed unit (DU) to a radio unit (RU).

FIGS. 3 and 4 show examples of message configurations that support beam weight transfer from a DU to an RU.

FIG. 5 shows an example of a process flow that supports beam weight transfer from a DU to an RU.

FIG. 6 shows a block diagram of a processing system that supports beam weight transfer from a DU to an RU.

FIG. 7 shows a diagram of a system including a device that supports beam weight transfer from a DU to an RU.

FIGS. 8 through 11 show flowcharts illustrating methods that support beam weight transfer from a DU to an RU.

Details of aspects and advantages of the subject matter in this disclosure are set forth in the drawings and accompanying descriptions. Like reference numbers and designations in the various drawings indicate like elements.

### DETAILED DESCRIPTION

A communication system may include a radio access network (RAN) that supports wireless communication. Communication of a RAN may be performed in accordance with one or more radio access technologies (RATs), including 4G, 5G, or 6G, among others, including technologies not explicitly mentioned herein. A RAT may employ access technologies (such as multiplexing technologies) including code division multiple access (CDMA), time division multiple access (TDMA), frequency division multiple access (FDMA), orthogonal FDMA (OFDMA), single-carrier FDMA (SC-FDMA), time division synchronous code division multiple access (TD-SCDMA), or discrete Fourier transform spread orthogonal frequency division multiplexing (DFT-S-OFDM), among others. A RAT may support one or more service types, including machine type communication (MTC), massive MTC (mMTC), Internet of Things (IoT), narrowband IoT (NB-IoT), reduced capability (RedCap), enhanced mobile broadband (eMBB), ultra-reliable low-latency communication (URLLC), or public safety, among others.

To support these and other target verticals, a communication system (such as a RAN) may be designed to implement one or more of a modularized functional infrastructure, a disaggregated and service-based network architecture, network function virtualization, network slicing, multi-access edge computing, spatial processing or multipath techniques, IoT or RedCap device connectivity and management, industrial connectivity, licensed and unlicensed spectrum access, sidelink or other device-to-device (D2D) direct communication (such as vehicle-to-everything (V2X)), frequency spectrum expansion, overlapping spectrum use, small cell deployments, non-terrestrial network (NTN) deployments, device aggregation, advanced duplex communication (such as sub-band full-duplex (SBFD)), multiple-subscriber implementations, high-precision positioning, radio frequency (RF) sensing, network energy savings (NES), low-power signaling and radios, or artificial intelligence or machine learning (AI/ML), among other examples.

The foregoing and other technological improvements may support use cases such as voice calls, messaging, data transfer, streaming, wireless data centers, extended reality (XR) and metaverse applications, vehicle connectivity, holographic and mixed reality communication, autonomous and collaborative robots, sensing networks, gesture monitoring, human-brain interfacing, digital twin applications, asset management, and universal coverage using non-terrestrial or aerial platforms, among other examples. As the demand for connectivity continues to increase, further improvements may be implemented, and other RATs, including 6G and beyond, may be introduced to enable new applications and use cases. The systems, methods, and devices described herein may enable one or more of the foregoing technologies or new technologies or support one or more of the foregoing use cases or new use cases.

In some wireless communication systems, such as an open RAN (O-RAN) system, a first network entity (e.g., a distributed unit (DU)) may control beam weight parameters for a second network entity (e.g., a radio unit (RU)). For example, the RU may support beamforming operations for signal transmission, signal reception, or both. In some examples, the RU may support analog beamforming, digital beamforming, or hybrid beamforming. To perform beamforming, the RU may apply different beamforming weight values to different antennas (e.g., antenna array elements, physical antennas, antenna ports) at the RU. In some examples, the RU may apply a respective beamforming weight compression parameter, a respective beamforming weight in-phase value, a respective beamforming weight quadrature value, or any combination of these or other beam weight parameters to each antenna of a set of antennas to form a communication beam. The communication beam may be identified according to a specific beam identifier (ID) or index value, and the communication beam may be associated with a specific beam direction and beam width (e.g., based on the beamforming weight values). The RU may maintain a codebook of communication beams, where the codebook indicates respective sets of beam weight parameters corresponding to beam IDs.

Aspects of the subject matter described in this disclosure relate to beam weight transfer from a DU to an RU. For example, a DU may send (e.g., transmit, or otherwise output) a message to an RU that indicates a beam weight update. In some examples, to indicate the beam weight update, the message may indicate respective sets of beam weight parameters for a set of communication beams. The RU may obtain (e.g., receive) the message and may update a codebook of beam weights maintained at the RU based on the indicated beam weight parameters. In some examples, the message may include a section with a section type, X, associated with a beam weight update. For example, the section type X may indicate that the section includes updates to one or more beam weight parameters for the RU. X may be any integer that is unassociated with a different purpose for a section, such as 2, 12, or any other value of X. In some other examples, the message may include a section with a section type, 4, associated with a slot level configuration and a command type, Y, associated with the beam weight update. For example, the command type Y may indicate that the section of section type 4 includes updates to one or more beam weight parameters for the RU. Y may be any integer that is unassociated with a different purpose for a section of section type 4, such as 5 (e.g., 0×5) or another value of Y. The section with section type X or section type 4 and command type Y may include fields that support the beam weight update.

The message indicating the beam weight update may additionally trigger a feedback mechanism at the RU. For example, the message may include an acknowledgment request identifier (ID) value. The acknowledgment request ID value may indicate that the DU requests a positive acknowledgment (ACK) or a negative acknowledgment (NACK) of the beam weight update at the RU. If the RU successfully receives the message and updates its codebook with the indicated beam weight parameters, the RU may send (e.g., transmit, or otherwise output) a second message indicating an ACK. The DU may obtain (e.g., receive) the second message indicating the ACK and may determine that the RU has completed the beam weight update. Alternatively, if the RU unsuccessfully processes the message or fails to update its codebook with the indicated beam weight parameters, the RU may send (e.g., transmit, or otherwise output) the second message indicating a NACK. The DU may obtain (e.g., receive) the second message indicating the NACK or may fail to obtain a second message indicating an ACK or NACK (e.g., an ACK/NACK message) from the RU (e.g., if the RU failed to receive the message and did not transmit an ACK/NACK message). In some examples, the DU may trigger a retransmission of the message indicating the beam weight update for the RU based on the NACK or based on failing to obtain an ACK/NACK message.

In some examples, the message indicating the beam weight update may include one or more format type subsections. A format type subsection may include the respective sets of beam weight parameters for the set of communication beams to update at the RU. For a first format type (e.g., Format Type 0), the DU may include, in a format type subsection, a single beam ID that indicates the set of communication beams corresponding to consecutive beams IDs (e.g., starting with the single beam ID) and a single beamforming weight compression parameter for the set of communication beams. For a second format type (e.g., Format Type 1), the DU may include, in a format type subsection, a respective beam ID and a respective beamforming weight compression parameter for each communication beam of the set of communication beams. For a third format type (e.g., Format Type 2), the DU may include, in a format type subsection, a single beam ID that indicates the set of communication beams corresponding to consecutive beams IDs (e.g., starting with the single beam ID) and respective beamforming weight compression parameters for each communication beam of the set of communication beams. In some examples, the message may support different format type subsections, such that the DU may include one or more Format Type 0 subsections, one or more Format Type 1 subsections, one or more Format Type 2 subsections, or any combination thereof in the message to indicate the beam weight update.

Particular aspects of the subject matter described in this disclosure can be implemented to realize one or more of the following potential advantages. In some examples, by supporting beam weight transfer from a DU to an RU, the described techniques can be used to improve communication beam flexibility at the RU. For example, the DU may semi-statically or dynamically command the RU to update a codebook of beam weights to support new communication beam configurations, improving communication reliability and throughput at the RU. In some examples, by using a section type X that is associated with a beam weight update or a section type 4 command type Y that is associated with the beam weight update, the described techniques may improve a signaling overhead associated with the DU updating beam weights at the RU. For example, a section with section type X or section type 4 command type Y may include fields relevant to the beam weight update and may not include fields irrelevant to the beam weight update, improving the message size for signaling the beam weight update. Additionally, or alternatively, by supporting a feedback mechanism at the RU, the message may improve coordination between the DU and the RU, such that the DU may determine whether the RU successfully completed the indicated beam weight update. The DU may refrain from assigning a communication beam with updated beam weights for signaling at the RU if the RU indicates a NACK for the beam weight update, improving communication reliability for the RU. In some examples, the DU may trigger resending the beam weight update based on the NACK, improving the latency involved in completing the beam weight update at the RU. Additionally, or alternatively, by supporting multiple different format type subsections within the message, the DU may flexibly select format types that efficiently indicate the beam weight update, improving flexibility and signaling overhead associated with the message.

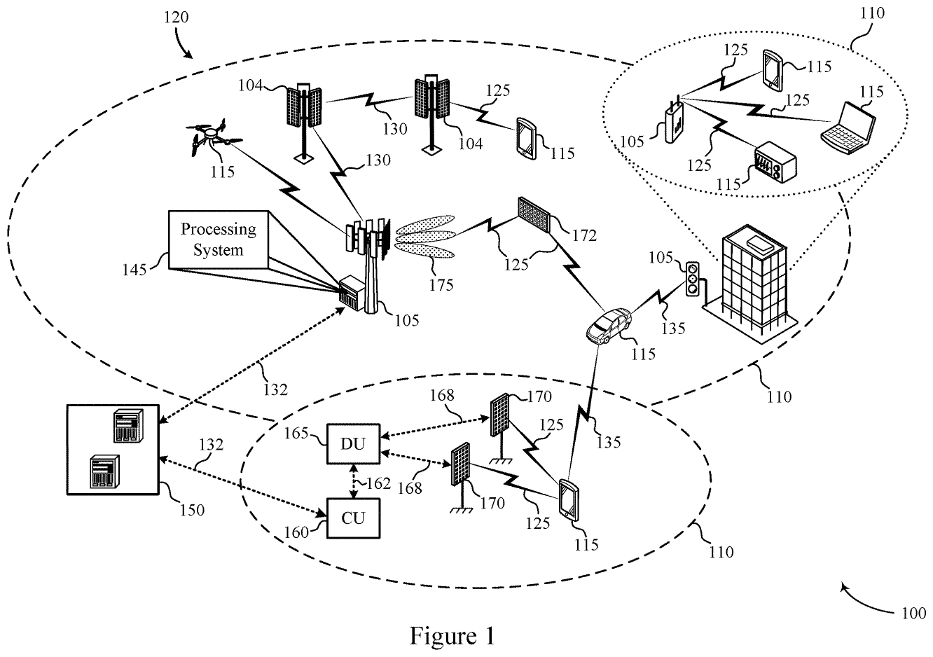

FIG. 1 shows an example of a wireless communication system 100. The wireless communication system 100 includes a core network 150 and a RAN 120 that support communication with one or more devices, such as UEs 115. A RAN 120 may include one or more network entities 105 configured to support wireless communication with the UEs 115.

The wireless communication system 100 may support communication among network entities 105 and UEs 115 in accordance with a layered protocol stack. For example, in a user plane, communication at a bearer layer, a Packet Data Convergence Protocol (PDCP) layer, or Service Data Adaption Protocol (SDAP) layer may be Internet Protocol (IP)-based. A Radio Link Control (RLC) layer may perform packet segmentation and reassembly to communicate via logical channels. A Medium Access Control (MAC) layer may perform priority handling and multiplexing of logical channels into transport channels. A MAC layer also may implement error detection techniques, error correction techniques, or retransmissions. In a control plane, a Radio Resource Control (RRC) layer may provide establishment, configuration, and maintenance of an RRC connection between UEs 115 and a network entity 105 or a core network 150, supporting radio bearers for user plane data. A Physical (PHY) layer may map transport channels to physical channels.

A core network 150 may support user authentication, access authorization, tracking, IP connectivity, and other access, routing, or mobility functions (such as via network entities 105). A core network 150 may be a 5G core (5GC) or 6G core (6GC), and may include at least one control plane entity that manages access and mobility and at least one user plane entity that routes packets or interconnects to external networks (such as a serving gateway (S-GW), a Packet Data Network (PDN) gateway (P-GW), a user plane function (UPF)).

A network entity 105 may support wireless communication in accordance with one or more coverage areas 110, and may be referred to as a network element, a network node, a RAN node, or network equipment, among other nomenclature. One or more of the network entities 105 may include or may be referred to as a base station. Depending on its capabilities, a base station may be referred to as a NodeB, an eNodeB (eNB), a next-generation NodeB or giga-NodeB (either of which may be referred to as a gNB), a 5G NB, a 6G NB, a next-generation eNB (ng-eNB), a Home NodeB, a Home eNodeB, or other suitable terminology. The wireless communication system 100 may include a heterogeneous network in which different types of network entities 105 support communication for one or more coverage areas 110 using the same or different RATs.

In some examples, a network entity 105 may be implemented in an aggregated (such as monolithic, standalone) architecture, which may utilize a protocol stack that is physically or logically integrated within one network entity 105 (such as a single physical RAN node). In some other examples, a network entity 105 may be implemented in a disaggregated architecture, which may utilize a protocol stack that is physically or logically distributed among multiple network entities 105, including in an integrated access and backhaul (IAB) network, an open RAN (O-RAN), or a virtualized RAN (vRAN). In a disaggregated architecture, a network entity 105 may include or be referred to as one or more of a central unit (CU) (such as CU 160), a DU (such as DU 165), an RU (such as RU 170), or a combination thereof. The wireless communication system 100 may also implement a service-based architecture that provides a modular framework in which control plane functionality and common data repositories may be delivered through a set of interconnected network functions (NFs) that may access services of other NFs.

UEs 115 may be located in a coverage area 110 of one or more network entities 105 and may include or be referred to as an access terminal, a mobile station, a client device, or a subscriber unit. A UE 115 may be, include, or be coupled with a cellular phone, a wireless modem, a tablet device, a laptop computer, a wireless local loop (WLL) station, a camera, a medical or biometric device, a wearable device, a gaming device, an entertainment device, an XR device, a vehicular component or sensor, a smart meter or sensor, industrial manufacturing equipment, a Global Positioning System (GPS) or other positioning device, a robot or other device implementing artificial intelligence, a UE function of a network node, or any other wireless communication device or function that may communicate using a wireless medium.

The wireless communication system 100 may support various types of communication links among devices. For example, wireless communication between a network entity 105 and a UE 115 may be supported using one or more of a communication link 125 (such as a Uu interface), which may include downlink communication from a network entity 105 to a UE 115, uplink communication from a UE 115 to a network entity 105, or both. Direct wireless communication between UEs 115 may be supported using a communication link 135 (such as a device-to-device (D2D) communication link, a sidelink, a PC5 interface).

Communication between a network entity 105 and a core network 150 may be supported using a backhaul link 132 (such as an S1, N2, N3, NG, or other interface). In some implementations, communication between network entities 105 may be supported using a backhaul link 132 (such as an X2, Xn, or other interface) either directly (such as directly between network entities 105) or indirectly (such as via a core network 150). In some implementations (such as in a disaggregated architecture), communication between a CU 160 and a DU 165 may be supported using a midhaul link 162, and communication between a DU 165 and an RU may be supported using a fronthaul link 168. A backhaul link 132, a midhaul link 162, a fronthaul link 168, or any combination thereof may be or include one or more wired links (such as an electrical link, an optical fiber link) or one or more wireless links (such as a radio link, a wireless optical link), among other examples or combinations thereof. Wireless backhaul, midhaul, or fronthaul may be implemented via one or more IAB nodes 104, which may act as a relay using resources of an IAB donor network entity 105 (such as via a wireless link 130).

The wireless communication system 100 may include one or more of a relay 172 that may steer or reflect signals transmitted by other entities, which may support any of the described communication links. A relay 172 may include active elements or passive elements, and may be in the form of a reconfigurable intelligent surface (RIS). An RIS may include tunable reflecting antenna arrays or metasurfaces, which may be used to enhance coverage or efficiency in multipath environments.

Network entities 105 and UEs 115 each may include one or multiple antennas. Multiple antennas of such devices may be used to employ techniques such as transmit diversity, receive diversity, MIMO communication, or beamforming, and may be organized or structured as one or more antenna panels, one or more antenna groups, one or more sets of antenna elements, or one or more antenna arrays, among other examples. As used herein, the term “antenna” may refer to one or more antennas, one or more antenna panels, one or more antenna groups, one or more sets of antenna elements, or one or more antenna arrays. The term “antenna panel” may refer to a group of antennas (such as antenna elements) arranged in an array or panel, which may facilitate beamforming by manipulating parameters associated with the group of antennas. In some implementations, an antenna panel may support RF beamforming for a signal transmitted or received via an antenna port. The term “antenna module” may refer to circuitry including one or more antennas as well as one or more other components (such as filters, amplifiers, processors, beamformers) associated with integrating the antenna module into a device such as a network entity 105 or a UE 115.

Beamforming, such as directional transmission or directional reception, is a signal processing technique that may be used at a transmitting device or a receiving device (such as at a network entity 105, at a UE 115) to shape or steer a beam 175 (such as an antenna beam, a transmit beam, a receive beam) along a spatial path (such as along a direction), which may include one or more paths between a transmitting device and a receiving device. Beamforming may be achieved by combining signals communicated via multiple antenna elements of an antenna array such that signals propagating along some orientations (such as relative to the antenna array) experience constructive interference while others may experience destructive interference. Adjustments of signals communicated via the antenna elements may include a transmitting device or a receiving device applying phase offsets, amplitude offsets, or other adjustments to signals carried via (such as transmitted by, received by) antenna elements of the device, which may be defined by a beamforming weight set associated with a particular orientation (such as relative to the antenna array of the device).

Communication resources of the wireless communication system 100 (such as of a RAN 120) may refer to a resource in the frequency domain (such as a frequency resource, an RF resource), a resource in the time domain (such as a time resource), a resource in the spatial domain (such as a spatial resource, a spatial layer), or a combination thereof. The wireless communication system 100 may leverage orthogonality of such resources to convey different communications to or from different devices (such as for a communication link 125, for a communication link 135, for unicast communication, for multicast communication, for broadcast communication).

A frequency resource may refer to a frequency or range of frequencies (such as a bandwidth, a frequency channel) of a frequency band implemented for wireless communication. For example, a frequency resource may refer to a resource of a lower frequency band (such as Frequency Range 1 (FR1), between 425 MHz and 7.125 GHZ), a mid-band (such as Frequency Range 3 (FR3), between 7.125 GHz and 24.25 GHz), or an upper frequency band (such as Frequency Range 2 (FR2), between 24.25 GHz and 71 GHz). Communication in the upper frequency band may be referred to as millimeter wave (mmW) communication, and communication above an upper frequency band (such as between mmW and THz frequencies, between 100 GHz and 1 THz) may be referred to as sub-Terahertz (sub-THz) communication.

A frequency resource may refer to a “carrier” (such as a frequency channel), or portion thereof, and a carrier bandwidth may be referred to as a “system bandwidth.” A carrier may be subdivided in the frequency domain, including into subcarriers, bandwidth parts (BWPs), or both. For example, a resource block (RB), such as a physical resource block (PRB), may be defined in accordance with a set of subcarriers (such as twelve consecutive subcarriers in the frequency domain), and a BWP may be configured in accordance with a set of RBs (such as a set of contiguous RBs).

A frequency resource may be configured to carry either downlink communication or uplink communication (such as in a frequency division duplexing (FDD) configuration), or may be configured to carry both downlink and uplink communication (such as in a time division duplexing (TDD) configuration, in a sub-band full duplex (SBFD) configuration). One or more numerologies for a carrier may be supported, each associated with a subcarrier spacing (SCS) and a cyclic prefix (CP). Supported numerologies may vary by frequency range (such as FR1, FR2, FR3), and a carrier may be divided into portions (such as BWPs) having the same or different numerologies. BWPs may be configured as uplink BWPs or downlink BWPs (such as by a network entity 105), including in response to network conditions (such as to allocate uplink and downlink BWPs in response to traffic conditions), device capability (such as allocating BWPs with a greater quantity of RBs to UEs 115 with relatively higher capabilities), or both. A UE 115 may be configured with a set of multiple BWPs (such as a set of uplink BWPs, a set of downlink BWPs, or both), and a single BWP of a set (such as an active UL BWP, an active DL BWP, or both) may be active at a given time, such that communication of a UE 115 is supported by active BWP(s).

A time resource may refer to a duration of a frame (such as a radio frame, a frame structure), or portion thereof. For example, a frame may span a duration of 10 ms, and each frame may be identified by a system frame number (SFN). A frame may be subdivided in the time domain, including into subframes, slots, mini-slots, or a combination thereof. Slots or mini-slots may each include a respective quantity of symbols (such as symbol durations, symbol periods, OFDM symbols), which may be a function of a configured CP. A duration of a symbol is a function of the SCS or frequency band of operation.

A spatial resource may refer to an antenna, an antenna direction, an antenna port, a signal direction (such as a beamforming direction), or other resource that supports spatial orthogonality. A device (such as a network entity 105, a UE 115) may perform communications of a given frequency resource and time resource with a single spatial resource (such as communication without regard to spatial orthogonality). Additionally, or alternatively, a device may implement multiple spatial resources to support multiple signal streams using resources that are overlapping in the time and frequency domains (such as to support MIMO techniques).

Signals of the wireless communication system 100 (such as of a RAN 120) may be communicated using one or more resource elements (REs), and an RE may refer to a resource that corresponds to one subcarrier in the frequency domain and one symbol in the time domain. An RE may be used to convey a modulation symbol corresponding to one or more bits of information (such as of a physical channel, of a reference signal) in accordance with a modulation scheme. For example, a quadrature phase shift keying (QPSK) or quadrature amplitude modulation (QAM) technique may be implemented to communicate one or more bits that are distinguished in accordance with phase components, amplitude components, or both of a signal conveyed using a RE. A quantity of bits carried by an RE may depend on an order of the modulation scheme, and a relatively higher order may correspond to a relatively higher rate of communication. A device may support communication of REs using multiple subcarriers concurrently by implementing multi-carrier modulation (MCM) techniques such as orthogonal frequency division multiplexing (OFDM) or discrete Fourier transform spread OFDM (DFT-S-OFDM), among others.

Physical channels may carry information using modulation symbols conveyed by corresponding REs. Physical shared channels (such as for communicating user data) may include a physical downlink shared channel (PDSCH) for communicating user data in a downlink direction and a physical uplink shared channel (PUSCH) for communicating user data in an uplink direction. Physical control channels (such as for managing communication via physical channels) may include a physical downlink control channel (PDCCH) for communicating downlink control information (DCI) and a physical uplink control channel (PUCCH) for communicating uplink control information (UCI). A network entity 105 may indicate (such as schedule, allocate) communication resources for a UE 115 using DCI, including indicating downlink resources of a PDSCH (such as in accordance with a downlink grant), uplink resources of a PUSCH (such as in accordance with an uplink grant), or a combination thereof. A control region (such as a control resource set (CORESET)) for a physical control channel may be configured in accordance with a pattern of REs in the time and frequency domains, and one or more control regions may be configured for a set of UEs. A UE 115 may monitor control regions for control information according to one or more search space sets, which may include a common search space set (such as for sending control information to one or more UEs 115), UE-specific search space sets (such as for sending control information to a UE 115), or a combination thereof. A physical broadcast channel (PBCH) may be used to broadcast parameters to UEs 115 to synchronize with a network entity 105 and establish communications (such as to establish a communication link 125).

Reference signals may be communicated to establish reference characteristics (such as a frequency reference, a temporal reference, a spatial reference, a signal quality reference) between devices of a RAN 120, which may support communication using physical channels. Reference signals communicated between network entities 105 and UEs 115 may include synchronization signals (such as a primary synchronization signal (PSS), a secondary synchronization signal (SSS)) that support temporal synchronization, channel state information-reference signals (CSI-RSs) that support evaluating downlink channel characteristics, sounding reference signals (SRSs) that support evaluating uplink channel characteristics, demodulation reference signals (DMRSs) that support demodulation, or phase tracking reference signals (PTRSs) for evaluating oscillator characteristics, among others. Network entities 105 and UEs 115 may receive and measure transmitted reference signals to support one or more of these and other functions.

Beamforming techniques may include analog beamforming, for which at least some signal processing (such as phase shifting, amplification, signal combination) is performed in an analog domain (such as using analog components, including analog phase shifters and amplifiers, for processing respective signals of individual antenna elements). Additionally (such as in accordance with hybrid beamforming), or alternatively, beamforming techniques may include digital beamforming, for which at least some signal processing is performed in a digital domain (such as using digital processing techniques for processing respective signals of individual antenna elements).

A network entity 105 or a UE 115 may use beam sweeping techniques as part of beamforming operations. For example, a network entity 105 may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a specific receiving device, may be transmitted by a transmitting device (e.g., a network entity 105 or a UE 115) along a single beam direction (e.g., a direction associated with the receiving device, such as another network entity 105 or UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105, a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network entity 105), such as synchronization signals, reference signals, beam selection signals, or other control signals. For example, a receiving device may perform reception in accordance with multiple receive directions by receiving via different antenna subarrays, by receiving according to different receive beamforming weight sets applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communication system 100 may be an example of an O-RAN system. In the O-RAN system, a DU 165 (e.g., an O-RAN DU (O-DU)) may manage one or more RUs (e.g., including an O-RAN RU (O-RU), such as an RU 170). The DU 165 may provide beam weight updates to an RU 170 in accordance with a messaging protocol. For example, the DU 165 may transmit a first message to the RU 170 that indicates one or more beam weight updates and an acknowledgment request ID. The RU 170 may receive the first message and may update a codebook at the RU 170 that indicates respective sets of beamforming weights for communication beams supported by the RU 170. The RU 170 may transmit, in response to the first message, a second message that includes acknowledgment information. For example, the second message may indicate whether the RU 170 successfully updated the codebook based on the indicated one or more beam weight updates. If the second message indicates that the beam weight updates were successful (e.g., using an ACK indication), the DU 165 may receive the second message and determine that the RU 170 supports the updated beam weights. However, if the second message indicates that the beam weight updates were unsuccessful (e.g., using a NACK indication), the DU 165 may determine to resend the beam weight updates.

Devices of the wireless communication system 100 may be configured to support one or more aspects of the described techniques for beam weight transfer from a DU 165 to an RU 170. For example, a network entity 105 (e.g., a network entity 105 including a DU 165, a network entity 105 including an RU 170, or both) may include a processing system 145, which may be configured to cause the network entity 105 to perform (such as being configured as means for performing) one or more of the described operations. By configuring a processing system 145 in accordance with the described techniques, the wireless communication system 100 (such as the RAN 120, which may be an example of an O-RAN system) may support improved coordination between the DU 165 and the RU 170, improved reliability and signaling overhead associated with beam weight updates from the DU 165 to the RU 170, or any combination thereof.

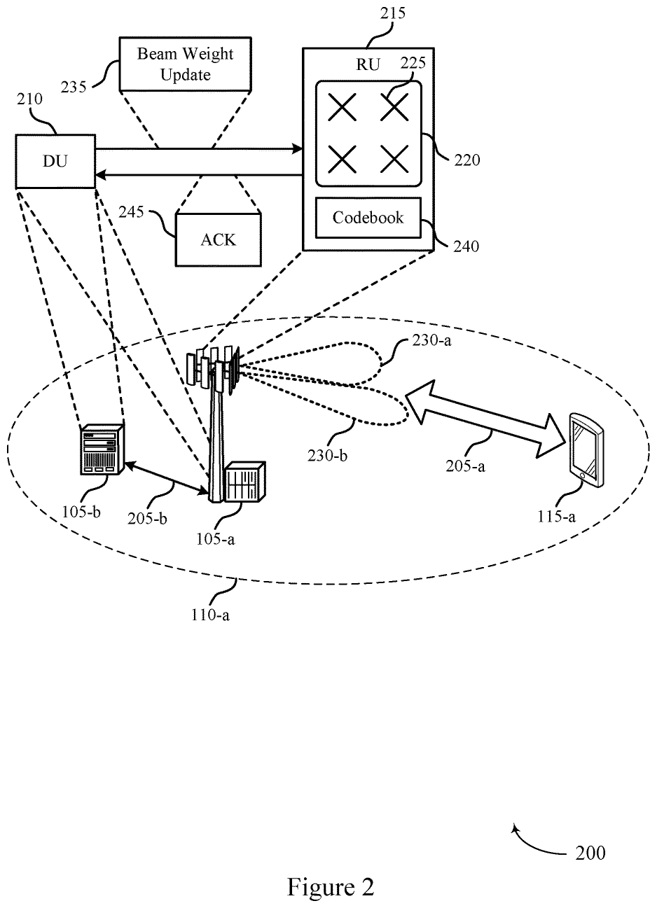

FIG. 2 shows an example of a signaling configuration 200 that supports beam weight transfer from a DU to an RU. A wireless communication system, such as the wireless communication system 100 as described with reference to FIG. 1, may support the signaling configuration 200. For example, a first network entity 105-a may provide network coverage for a coverage area 110-a. The first network entity 105-a may be an example of a network entity 105 described with reference to FIG. 1. For example, the first network entity 105-a may be a base station or other network device that includes an RU 215. The first network entity 105-a may communicate, via a first communication link 205-a (e.g., a wireless link), with a UE 115-a, which may be an example of a UE 115 as described with reference to FIG. 1. In some examples, the first network entity 105-a may additionally include a DU 210 that manages, or otherwise controls, one or more RUs, including the RU 215. In some other examples, a second network entity 105-b may include the DU 210 that manages the one or more RUs, including the RU 215. The first network entity 105-a (e.g., a network entity 105 including at least an RU 215) and the second network entity 105-b (e.g., a network entity 105 including at least a DU 210) may communicate via a second communication link 205-b (e.g., a wireless or wired link). The DU 210 may update beamforming weights at the RU 215 using a beam weight transfer mechanism.

The RU 215 may control beamforming weights using a codebook 240, an antenna panel 220, or both. For example, the network entity 105-a may include an antenna panel 220 with a set of antennas 225. As used herein, an “antenna” may refer to a physical antenna, a logical antenna port, or some combination thereof. The RU 215 may achieve transmit diversity, receive diversity, spatial multiplexing, or any combination thereof by applying different beamforming weights to different antennas 225 of the antenna panel 220. For example, by precoding a signal for transmission using a first set of beam weights, the RU 215 may transmit the signal via a first communication beam 230-a with a first beam identifier (ID). In contrast, by precoding the signal for transmission using a second set of beam weights, the RU 215 may transmit the signal via a second communication beam 230-b with a second beam ID. The codebook 240 may store the sets of beam weights corresponding to the different communication beams (e.g., with the different beam IDs). Different communication beams may have different beam widths, different beam directions, different transmit or receive powers, or any combination of these or other parameters based on the corresponding sets of beam weights. The codebook 240 may be an example of an O-RU codebook with beamforming weights for precoding at the RU 215. The codebook 240 may support the precoding of signals to transmit from the RU 215, the precoding of signals received at the RU 215, or both.

In some systems (e.g., O-RAN systems), the DU 210 may control beam weights at one or more RUs. For example, the DU 210 may configure the RU 215 with a set of beam weights to use for communications. The RU 215 may store the configured set of beam weights at the codebook 240. In some examples, the DU 210 and the RU 215 may additionally support a mechanism for transferring beam weight information from the DU 210 to the RU 215 to update the codebook 240 at the RU 215 before applying the beam weight information for a communication (e.g., for signal transmission or reception via the communication link 205-a).

The DU 210 may output (e.g., transmit, or otherwise send) a first message that indicates a beam weight update 235 to the RU 215. The DU 210 may semi-statically or dynamically (e.g., in real-time or pseudo-real-time) update beamforming weights at the RU 215 using the beam weight update 235. In some implementations (e.g., if the same network entity 105-a includes both the DU 210 and the RU 215), the DU 210 may send the RU 215 the first message internal to the network entity 105-a (e.g., via a wired or wireless connection). In some other implementations (e.g., if the DU 210 and the RU 215 are included at separate, or otherwise disaggregated, network entities 105), the network entity 105-b may send the first message to the network entity 105-a via the communication link 205-b (e.g., a wireless connection). The RU 215 may obtain (e.g., receive) the first message that indicates the beam weight update 235.

Some other systems may use a message that includes a combination of a Section Type 1 section with a Section Extension 1 or a Section Extension 11 to update an O-RU codebook with beamforming weights. The Section Type 1 section may indicate that the message is a control message for uplink or downlink data. The Section Type 1 section may support scheduling and beamforming commands. For example, a DU may set the resource element mask (reMask) field in the Section Type 1 section to 0 to indicate the absence of real data traffic scheduled by the message. The DU may set values in the Section Extension 1 or the Section Extension 11 of the message to indicate specific beamforming weight values to update. However, such a message may fail to efficiently and reliably update the beamforming weights at an RU.

For example, the DU may refrain from referencing the same section ID for different sets of resource blocks (RBs), regardless of whether the reMask field indicates the presence or absence of scheduled data. In some implementations, the DU may use a specific section ID value to indicate updating the beamforming weights, such as section ID=4095 (or some other value). However, refraining from using this section ID value for different sets of RBs may significantly reduce the capability of the DU to indicate beam weight updates for multiple sets of RBs, limiting the flexibility of beam weight updates for such systems using this message.

Additionally, or alternatively, the RU may configure a management plane (M-plane) parameter that indicates a quantity of control sections per data sections. Using a Section Type 1 section (e.g., a control section) to update beam weights without a corresponding data section (e.g., based on the reMask field set to 0) may violate the quantity of control sections per data sections configured by the RU, potentially causing the RU to inefficiently monitor for a non-existent data section or trigger an error response.

Additionally, or alternatively, the Section Type 1 section may not support an acknowledgment mechanism. Accordingly, the DU may fail to track whether the RU has successfully updated its codebook based on a beam weight update. If the RU drops the message or fails to properly receive or process the message, this may be transparent, or otherwise unknown, to the DU. The DU may assign a beam for communication that was not properly updated at the RU, resulting in communication failures at the RU. Accordingly, using the message that includes a combination of the Section Type 1 section with the Section Extension 1 or the Section Extension 11 to update the beam weights may reduce both the reliability of the beam weight updates and the coordination between the DU and the RU.

Additionally, or alternatively, the Section Type 1 section, the Section Extension 1, the Section Extension 11, or a combination thereof may include fields (e.g., information elements (IEs)) that are unused—or otherwise redundant—for the beam weight updates. For example, the Section Type 1 section may include, in a Common Section Header, a filter index (filterIdx) field, a user data compression header (udCompHdr) field, or both that are unused for the beam weight updates. The Section type 1 section may include, in a Section Description, a section ID field, an RB indicator field, a symbol number increment command (symInc) field, a starting physical resource block (PRB) of data section description (startPrbc) field, a reMask field, a number of symbols (numSymbol) field, a beam ID field, or any combination thereof that are unused for the beam weight updates. The Section Extension 11 may include, in a Section Extension Description, a disable beamforming weights (disableBFWs) field, a reset after PRB discontinuity (RAD) field, a PRB bundle offset (bundleOffset) field, a number of bundled PRBs (numBundPrb) field, or any combination thereof that are unused for the beam weight updates. Such unused fields may increase the message size without providing any useful information for the RU. Accordingly, using the message that includes a combination of the Section Type 1 section with the Section Extension 1 or the Section Extension 11 to update the beam weights may include unused fields that increase the signaling overhead without improving the information throughput of the message. Such messaging may be inefficient.

In contrast, the signaling configuration 200 may support a feedback mechanism and efficient resource usage for the message that indicates the beam weight update 235. In some examples, the message may include a section with a Section Type that is associated with beam weight sending. That is, the Section Type may be configured specifically for the beam weight update 235. This Section Type may be a Section Type X, where X may be any integer that is unassociated with a different use case. For example, Section Type 2, Section Type 12, or some other Section Type may be used for the beam weight update 235. The Section Type X section may include a payload indicating respective sets of beam weight parameters for a set of communication beams and an acknowledgment request identifier. The respective sets of beam weight parameters may support the beam weight updates, and the acknowledgment request identifier may support the feedback mechanism for acknowledging a successful beam weight update.

In some other examples, the message may include a Section Type 4 section with a Section Type 4 Command Type that is associated with beam weight sending. That is, the Section Type 4 section may be associated with a slot level configuration, and the Command Type may be configured specifically for the beam weight update 235. This Section Type 4 Command Type may be a Command Type Y, where Y may be any integer that is unassociated with a different use case. For example, Command Type 5 (e.g., 0×5) or some other Command Type Y (e.g., 0×Y) may be used for the beam weight update 235. The Section Type 4 section with the Command Type Y may include a payload indicating respective sets of beam weight parameters for a set of communication beams and an acknowledgment request identifier. The respective sets of beam weight parameters may support the beam weight updates, and the acknowledgment request identifier may support the feedback mechanism for acknowledging a successful beam weight update.

The DU 210 may output the message with the beam weight update 235 for the RU 215 (e.g., via the communication link 205-b). The RU 215 may receive the message with the beam weight update 235. The RU 215 may update the codebook 240 based on the message with the beam weight update 235. For example, the RU 215 may update the codebook 240 to indicate the respective sets of beam weight parameters for the set of communication beams. In some examples, updating the codebook 240 may be referred to as applying the respective sets of beam weight parameters for the set of communication beams at the RU 215. If the RU 215 successfully receives the message with the beam weight update 235 and updates the codebook 240, the RU 215 may transmit a second message indicating an ACK 245 based on the acknowledgment request identifier. For example, the RU 215 may transmit the second message including the ACK 245 in response to, or otherwise based on, the first message. In some examples, the ACK 245 may acknowledge successful reception and processing of the first message at the RU 215, successful reception and processing of the beam weight update 235 at the RU 215, successful application of the respective sets of beam weight parameters for the set of communication beams at the RU 215 (e.g., successful updating of the codebook 240), or any combination thereof. The DU 210 may receive the second message indicating the ACK 245 for the RU 215 (e.g., via the communication link 205-b). Based on the ACK 245, the DU 210 may determine that the RU 215 successfully updated its beam weights (e.g., as stored at the codebook 240) in accordance with the beam weight update 235.

The DU 210 may schedule the RU 215 for communications based on the beam weight update 235 being successful. For example, the DU 210 may transmit a message to the RU 215 that schedules the RU 215 for communications using a communication beam of the set of communication beams. For example, the message may include a beam ID associated with the communication beam. The RU 215 may determine the beamforming weights to use for the indicated beam ID based on the codebook 240 updated in accordance with the beam weight update 235. The RU 215 may apply the beamforming weights to one or more antennas 225 of the antenna panel 220 to transmit a signal, receive a signal, or both based on the message, the codebook 240, and the success of the beam weight update 235.

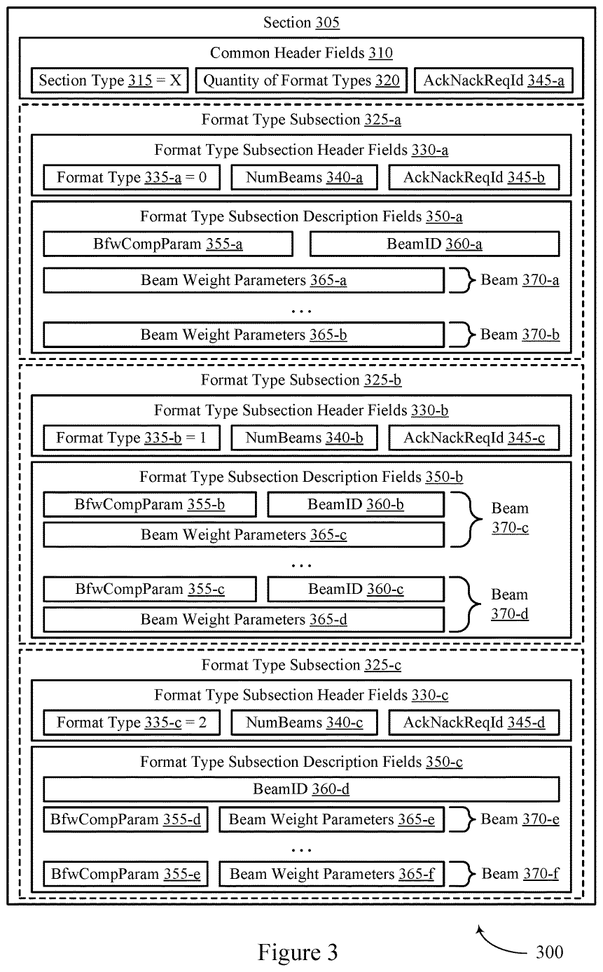

FIG. 3 shows an example of a message configuration 300 that supports beam weight transfer from a DU to an RU. The message configuration 300 may support a message, such as the first message with the beam weight update 235 as described with reference to FIG. 2. For example, a DU may transmit the message with the message configuration 300 to an RU to indicate a beam weight update to the RU. The DU may be an example of a DU 210, a DU 165, a first network entity 105, or any combination thereof as described with reference to FIGS. 1 and 2. The RU may be an example of an RU 215, an RU 170, a second network entity 105, or any combination thereof as described with reference to FIGS. 1 and 2. The message may include a Section Type X section 305, where X may be an integer associated with a beam weight update. That is, the section type 315 with the value X may be configured to support beam weight sending from the DU to the RU. Section Type X may additionally trigger an acknowledgment response from the RU to the DU. The message with the Section Type X section 305 may support efficient and reliable beam weight transfer from the DU to the RU (e.g., from an O-DU to an O-RU in an O-RAN system).

A message (e.g., a control plane (C-Plane) message) may include a payload with a single section type 315. For example, the message may include one or more sets of section data (e.g., sections 305) of the same section type 315. However, sets of section data with different section types may be communicated via separate messages.

The section 305 may include a set of common header fields 310 and one or more format type subsections, such as a format type subsection 325-a, a format type subsection 325-b, a format type subsection 325-c, or any combination of these or additional format type subsections. The set of common header fields 310 may include the indication of the section type 315. For example, the section type 315 field may include a value indicating the section type for the section 305. As illustrated, the section type 315 field may indicate the Section Type X for the section 305, where the Section Type X is associated with beam weight updating. In some examples, the set of common header fields 310 may additionally indicate a quantity of format types 320. For example, the set of common header fields 310 may include a number of beamforming weight format types (numberOfBFWformatTypes) field that indicates the quantity of format types 320 included in the section 305. If the quantity of format types 320 indicates a value greater than one, the section 305 may include multiple different format types (e.g., in the format type subsections). Support for multiple different format types within the section 305 (e.g., mixing format types within the message) may improve the flexibility and signaling overhead associated with indicating beam weight updates.

Table 1 illustrates an example format for the set of common header fields 310 of the Section Type X section 305. The fields of Table 1 are organized into octets or bytes spanning 8 bits from a most significant bit (MSB) 0 to a least significant bit (LSB) 7.

TABLE 1
Section Type X-Example Section Header Fields
Section Type X: Beam Weight Sending

| | | | | | | | | Number | |
|---|---|---|---|---|---|---|---|---|---|
| | | | | | | | | of | Octet |
| 0 | 1 | 2 | 3 | 4 | 5 | 6 | 7 | Bytes | Start |

| Transport Header | | | 8 | 1 |
|---|---|---|---|---|
| dataDirection | payloadVersion | reserved | 1 | 9 |

| frameId | | 1 | 10 |
|---|---|---|---|
| subframeId | slotId | 1 | 11 |

| | | | |
|---|---|---|---|
| slotId | startSymbolId | 1 | 12 |

| | | |
|---|---|---|
| numberOfBFWformatTypes | 1 | 13 |
| section Type = X | 1 | 14 |
| ackNackRegId | 2 | 15 |

The message may include a transport header. The transport header may indicate data routing capabilities, such as a data flow type, sending and receiving port IDs, capability information relating to concatenation of multiple application messages in a single packet, sequence numbering, or any combination of these or other information indicating how to handle application data at the C-Plane, the user plane (U-Plane), or both. The transport header may start at Octet 1 and may include 8 bytes of information.

The section header (e.g., the common header fields 310) for Section Type X may include a data direction (dataDirection) field, a payload version (payloadVersion) field, reserved bits, a frame ID (frameId) field, a subframe ID (subframeId) field, a slot ID (slotId) field, a start symbol ID (startSymbolId) field, a numberOfBFWformatTypes field indicating the quantity of format types 320, a section type (sectionType) field indicating the section type 315 X, an ACK/NACK request ID (ackNackReqId) field that indicates an acknowledgment request ID 345-a, or any combination thereof. In some examples, the dataDirection field may include a 1-bit indication of the data direction (e.g., either transmission or reception for a gNB), and the payloadVersion field may include a 3-bit indication of a payload version. In some implementations, the payloadVersion field may be set to a value of 1 to indicate a first protocol version for the payload and time reference format. In some examples, the frameID field may include an 8-bit indication of a frame, the subframeId field may include a 4-bit indication of a subframe, the slotId field may include a 6-bit indication of a slot, the startSymbolId field may include a 6-bit indication of a start symbol, the numberOfBFWformatTypes field may include an 8-bit indication of the quantity of format types 320, and the section Type field may include an 8-bit indication of the section type 315. In some examples, the ackNackReqId field may include a 16-bit indication of the acknowledgment request ID 345-a.

The value of the section Type field (e.g., the value X) may indicate that the section 305, and correspondingly the message including the section 305, indicates a beam weight update. The acknowledgment request ID 345-a may correspond to the section 305, and correspondingly the message including the section 305. For example, if the acknowledgment request ID 345-a is set to a non-zero value, the acknowledgment request ID 345-a may trigger acknowledgment of successful reception and processing of the section 305 or the message including the section 305. A zero value for the acknowledgment request ID 345-a may not trigger an acknowledgment message.

In some examples, the section 305 may include a first format type subsection 325-a with Format Type 0. The first format type subsection 325-a may include format type subsection header fields 330-a and format type subsection description fields 350-a. The format type subsection header fields 330-a may indicate the format type 335-a of the first format type subsection 325-a (e.g., Format Type 0). Additionally, in some examples, the format type subsection header fields 330-a may indicate an acknowledgment request ID 345-b. For example, the format type subsection header fields 330-a may include an ackNackReqID field that indicates the acknowledgment request ID 345-b. In some examples, the acknowledgment request ID 345-b may be a 16-bit value that uniquely identifies the first format type subsection 325-a. The acknowledgment request ID 345-b may trigger a feedback mechanism at the RU for the first format type subsection 325-a. Additionally, or alternatively, the format type subsection header fields 330-a may indicate a quantity of beams 340-a, n. For example, the format type subsection header fields 330-a may include a number of beams (numBeams) field that indicates the quantity of beams 340-a. The quantity of beams 340-a may correspond to a quantity of consecutive communication beams to update in the codebook of the RU (e.g., according to the beam weight parameters indicated in the format type subsection description fields 350-a).

The format type subsection description fields 350-a may include a beamforming weight compression parameter (bfwCompParam) field that indicates a beamforming weight compression parameter 355-a. The format type subsection description fields 350-a may additionally include a beam ID (beamID) field indicating a beam ID 360-a. For Format Type 0, the beamforming weight compression parameter 355-a and the beam ID 360-a may be indicated once per Format Type Header (e.g., once per format type subsection 325-a). The beam ID 360-a may indicate a first beam ID to update. The quantity of beams 340-a may indicate a quantity of beams with consecutive beam IDs, starting with the first beam, to update. The beamforming weight compression parameter 355-a may apply to each beam of the set of communication beams (e.g., the n beams with consecutive beam IDs, starting with the beam ID 360-a). Accordingly, the RU may apply the same beamforming weight compression parameter 355-a to multiple beams, reducing a processing overhead at the RU and reducing a signaling overhead associated with the message.

The format type subsection description fields 350-a may additionally indicate the beam weight parameters. For example, the format type subsection description fields 350-a may indicate beam weight parameters for each antenna of a set of antennas for each beam of the set of communication beams. The beam weight parameters may include beamforming weight in-phase (bfwI) values, beamforming weight quadrature (bfwQ) values, or both. In some examples, the beam weight parameters may include frequency-domain values for frequency-domain beamforming, time-domain values for time-domain beamforming, or both for hybrid beamforming. For example, the beam weight parameters 365-a may include a first bfwI value for a first antenna for a first beam 370-a and a first bfwQ value for the first antenna for the first beam 370-a (e.g., corresponding to the beam ID 360-a), a second bfwI value for a second antenna for the first beam 370-a and a second bfwQ value for the second antenna for the first beam 370-a, and so on, such that the beam weight parameters 365-a indicate respective bfwI and bfwQ values for each antenna for the first beam 370-a. The format type subsection description fields 350-a may further include beam weight parameters for each beam of the set of communication beams. For example, the RU may increment the beam ID 360-a (e.g., by 1) to determine a second beam ID for a second beam of the set of communication beams, and the RU may apply a second set of beam weight parameters for the second beam. The RU may perform this beam weight update for each communication beam up to the n-1 communication beam, beam 370-b. The format type subsection description fields 350-a may include beam weight parameters 365-b for the set of antennas for the beam 370-b, such that beam weights are specified per beam of the set of communication beams.

Table 2 illustrates an example format of a Format Type 0 subsection of the Section Type X section 305.

TABLE 2
Section Type X-Example Format Type 0 Subsection
Section Type X: Beam Weight Sending

| | | | | | | | | Number | |
|---|---|---|---|---|---|---|---|---|---|
| | | | | | | | | of | Octet |
| 0 | 1 | 2 | 3 | 4 | 5 | 6 | 7 | Bytes | Start |

| Transport Header | | 8 | 1 |
|---|---|---|---|
| Section Type X Section Header | | 8 | 9 |
| formatType = 0 | numBeams | 1 | 17 |

| | | |
|---|---|---|
| numBeams | 1 | 18 |
| BFWformatTypeLen | 2 | 19 |
| bfwCompHdr | 1 | 21 |
| ackNackReqId | 2 | 22 |
| reserved | 1 | 24 |
| bfwCompParam (for next n beams) | var | |
| beamId (for beam 0) | 2 | |
| bfwI (for Antenna 0 and beam 0) | var | |
| bfwQ (for Antenna 0 and beam 0) | var | |
| . . . | | |
| bfwI (for Antenna L-1 and beam 0) | var | |
| bfwQ (for Antenna L-1 and beam 0) | var | |
| . . . | | |
| bfwI (for Antenna 0 and beam n-1) | var | |
| bfwQ (for Antenna 0 and beam n-1) | var | |
| . . . | | |
| bfwI (for Antenna L-1 and beam n-1) | var | |
| bfwQ (for Antenna L-1 and beam n-1) | var | |

The format type subsection 325-a may include format type subsection header fields 330-a including a formatType field indicating the format type 335-a. In some examples, the formatType field may include a 2-bit indication of the format type 335-a. If the format type 335-a is set to 0, the format type subsection 325-a may include a single beam ID 360-a and a single beamforming weight compression parameter 355-a. Consecutive sets of beam weight entries in the format type subsection 325-a may correspond to beams with incremental beam IDs and may use the same compression (e.g., based on the beamforming weight compression parameter 355-a). In some examples, the format type subsection header fields 330-a may additionally include a numBeams field (e.g., spanning 14 bits) indicating the quantity of beams 340-a (e.g., the number of beam defined in the format type subsection 325-a), a beamforming weight format type length (BFWformatTypeLen) field (e.g., spanning 16 bits) that indicates a length of the format type subsection 325-a, a beamforming weight compression header (bfwCompHdr) field (e.g., spanning 8 bits) that indicates the beamforming weight compression header, an ackNackReqId field (e.g., spanning 16 bits) that indicates the acknowledgment request ID 345-b for the beam weight updates indicated in the format type subsection 325-a, reserved bits, or any combination thereof.

The format type subsection 325-a may additionally include format type subsection description fields 350-a including a single bfwCompParam field indicating the beamforming weight compression parameter 355-a for n consecutive beams, a single beamID field indicating the beam ID 360-a of the first beam of the n consecutive beams, and respective bfwI and bfwQ fields for each antenna (e.g., from antenna 0 to antenna L-1 for a set of L antennas) for each beam of the n consecutive beams (e.g., from beam 0 to beam n-1).

In some examples, the section 305 may additionally, or alternatively, include a second format type subsection 325-b with Format Type 1. The second format type subsection 325-b may include format type subsection header fields 330-b and format type subsection description fields 350-b. The format type subsection header fields 330-b may be similar to, or the same as, the format type subsection header fields 330-a. For example, the format type subsection header fields 330-b may indicate the format type 335-b of the second format type subsection 325-b (e.g., Format Type 1). Additionally, in some examples, the format type subsection header fields 330-b may indicate an acknowledgment request ID 345-c, a quantity of beams 340-b, n, for beam weight updates, or both.

The format type subsection description fields 350-b may specify a beam ID and a beamforming weight compression parameter per beam for the quantity of beams 340-b, n, indicated in the format type subsection header fields 330-b. Additionally, the format type subsection description fields 350-b may specify sets of beam weight parameters per beam. For example, the format type subsection description fields 350-b may include a first bfwCompParam field that indicates a first beamforming weight compression parameter 355-b for a first beam 370-c. The format type subsection description fields 350-b may also include a first beamID field that indicates a first beam ID 360-b corresponding to the first beam 370-c. The format type subsection description fields 350-b may include a set of beam weight parameters 365-c. The format type subsection description fields 350-b may indicate respective beamforming weight compression parameters, beam IDs, and sets of beam weight parameters for each beam of the set of communication beams (e.g., the n beams). For example, the format type subsection description fields 350-b may include an n-1 bfwCompParam field that indicates a beamforming weight compression parameter 355-c for the n-1 beam 370-d, an n-1 beamId field that indicates a beam ID 360-c corresponding to the n-1 beam 370-d, and an n-1 set of beam weight parameters 365-d for the n-1 beam 370-d. The Format Type 1 may support flexible beam weight updates and may improve a signaling overhead associated with updating beam weights for non-contiguous beams.

Table 3 illustrates an example format of a Format Type 1 subsection of the Section Type X section 305. For Format Type 1, each set of beam weights may have a specific beam ID and a specific beamforming weight compression parameter assigned.

TABLE 3
Section Type X-Example Format Type 1 Subsection
Section Type X: Beam Weight Sending

| | | | | | | | Number | |
|---|---|---|---|---|---|---|---|---|
| | | | | | | | of | Octet |
| 0 | 1 2 | 3 | 4 | 5 | 6 | 7 | Bytes | Start |

| Transport Header | | 8 | 1 |
|---|---|---|---|
| Section Type X Section Header | | 8 | 9 |
| formatType = 1 | numBeams | 1 | 17 |

| | | |
|---|---|---|
| numBeams | 1 | 18 |
| BFWformatTypeLen | 2 | 19 |
| bfwCompHdr | 1 | 21 |
| ackNackReqId | 2 | 22 |
| reserved | 1 | 24 |
| bfwCompParam (for beam 0) | var | |
| beamId (for beam 0) | 2 | |
| bfwI (for Antenna 0 and beam 0) | var | |
| bfwQ (for Antenna 0 and beam 0) | var | |
| . . . | | |
| bfwI (for Antenna L-1 and beam 0) | var | |
| bfwQ (for Antenna L-1 and beam 0) | var | |
| . . . | | |
| bfwCompParam (for beam n-1) | var | |
| beamId (for beam n-1) | 2 | |
| bfwI (for Antenna 0 and beam n-1) | var | |
| bfwQ (for Antenna 0 and beam n-1) | var | |
| . . . | | |
| bfwI (for Antenna L-1 and beam n-1) | var | |
| bfwQ (for Antenna L-1 and beam n-1) | var | |

In some examples, the section 305 may additionally, or alternatively, include a third format type subsection 325-c with Format Type 2. The third format type subsection 325-c may include format type subsection header fields 330-c and format type subsection description fields 350-c. The format type subsection header fields 330-c may be similar to, or the same as, the format type subsection header fields 330-a and the format type subsection header fields 330-b. For example, the format type subsection header fields 330-c may indicate the format type 335-c of the third format type subsection 325-c (e.g., Format Type 2). Additionally, in some examples, the format type subsection header fields 330-c may indicate an acknowledgment request ID 345-d, a quantity of beams 340-c, n, for beam weight updates, or both.

The format type subsection description fields 350-c may specify a single beam ID 360-d for the third format type subsection 325-c, but may specify a beamforming weight compression parameter per beam for the quantity of beams 340-c, n, indicated in the format type subsection header fields 330-c. Additionally, the format type subsection description fields 350-c may specify sets of beam weight parameters per beam. For example, the single beam ID 360-d may correspond to a first beam (e.g., a base beam), and the third format type subsection 325-c may update beam weights for n beams with consecutive beam IDs starting with the beam ID 360-d (e.g., incrementing by 1 for each beam in the set of communication beams). The format type subsection description fields 350-c may include a first bfwCompParam field that indicates a first beamforming weight compression parameter 355-d for a first beam 370-e. The format type subsection description fields 350-c may also include a set of beam weight parameters 365-e for the first beam 370-e. The format type subsection description fields 350-c may indicate respective beamforming weight compression parameters and sets of beam weight parameters for each beam of the set of communication beams (e.g., the n beams). For example, the format type subsection description fields 350-c may include an n-1 bfwCompParam field that indicates a beamforming weight compression parameter 355-e for the n-1 beam 370-f and an n-1 set of beam weight parameters 365-f for the n-1 beam 370-f. The Format Type 2 may support efficiently signaling beam weight updates for beams with contiguous beam IDs but with different beamforming weight compression parameters.

Table 4 illustrates an example format of a Format Type 2 subsection of the Section Type X section 305. For Format Type 2, a single beam ID may be indicated for the Format Type 2 subsection, but a respective beamforming weight compression parameter and beamforming weights may be assigned for each beam.

TABLE 4
Section Type X-Example Format Type 2 Subsection
Section Type X: Beam Weight Sending

| | | | | | | | | Number | |
|---|---|---|---|---|---|---|---|---|---|
| | | | | | | | | of | Octet |
| 0 | 1 | 2 | 3 | 4 | 5 | 6 | 7 | Bytes | Start |

| Transport Header | | 8 | 1 |
|---|---|---|---|
| Section Type X Section Header | | 8 | 9 |
| formatType = 2 | numBeams | 1 | 17 |

| | | |
|---|---|---|
| numBeams | 1 | 18 |
| BFWformatTypeLen | 2 | 19 |
| bfwCompHdr | 1 | 21 |
| ackNackReqId | 2 | 22 |
| reserved | 1 | 24 |
| beamId (for beam 0) | 2 | |
| bfwCompParam (for beam 0) | var | |
| bfwI (for Antenna 0 and beam 0) | var | |
| bfwQ (for Antenna 0 and beam 0) | var | |
| . . . | | |
| bfwI (for Antenna L-1 and beam 0) | var | |
| bfwQ (for Antenna L-1 and beam 0) | var | |
| . . . | | |
| bfwCompParam (for beam n-1) | var | |
| bfwI (for Antenna 0 and beam n-1) | var | |
| bfwQ (for Antenna 0 and beam n-1) | var | |
| . . . | | |
| bfwI (for Antenna L-1 and beam n-1) | var | |
| bfwQ (for Antenna L-1 and beam n-1) | var | |

In some examples, the section 305 may include multiple format type subsections of the same format type, different format types, or both. For example, the Section Type X section 305 may support the interaction of multiple format types within the same section 305. Supporting multiple format types may enable a DU generating the message to indicate beamforming weights using an efficient technique based on the beamforming weight data, the RU supported configurations, or both. For example, based on the beam IDs to update, the beamforming weight compression parameters to update, or both, the DU may select whether to use Format Type 0, Format Type 1, Format Type 2, or a combination thereof. In some examples, the RU may indicate, to the DU, the RU's capability of applying the same beamforming weight parameters across multiple beams, and the DU may determine whether to use Format Type 0, Format Type 1, Format Type 2, or a combination thereof based on the RU's capability. Such flexibility may improve the signaling overhead of the message for different beam weight updates.

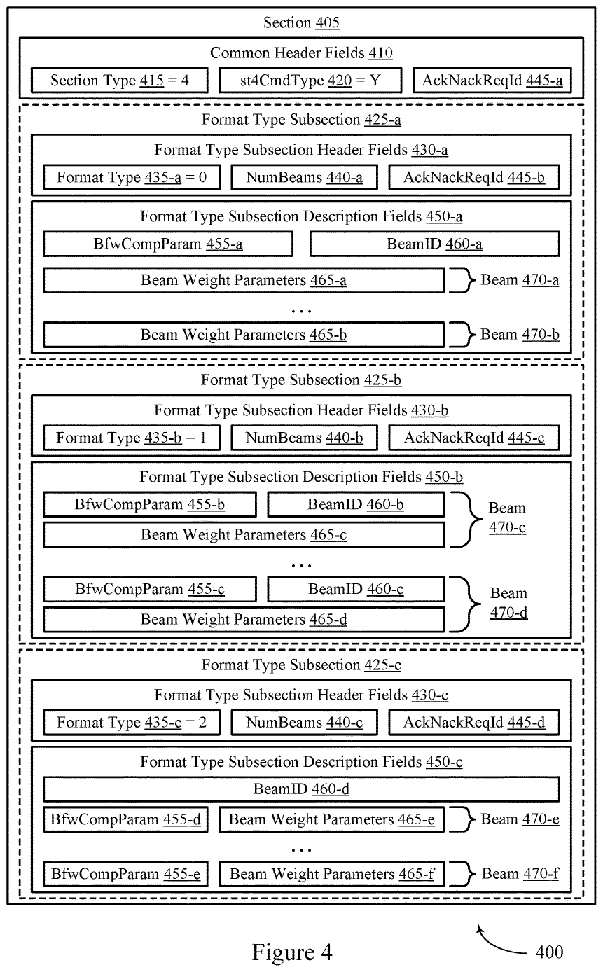

FIG. 4 shows an example of a message configuration 400 that supports beam weight transfer from a DU to an RU. The message configuration 400 may support a message, such as the first message with the beam weight update 235 as described with reference to FIG. 2. For example, a DU may transmit the message with the message configuration 400 to an RU to indicate a beam weight update to the RU. The DU may be an example of a DU 210, a DU 165, a first network entity 105, or any combination thereof as described with reference to FIGS. 1 and 2. The RU may be an example of an RU 215, an RU 170, a second network entity 105, or any combination thereof as described with reference to FIGS. 1 and 2. The message may include a Section Type 4 section 405. The Section Type 4 section 405 may include a command type 420 Y, where Y may be an integer associated with a beam weight update. That is, the command type 420 with the value Y may be configured to support beam weight sending from the DU to the RU. Section Type 4 with the command type 420 Y may additionally trigger an acknowledgment response from the RU to the DU. The message with the Section Type 4 section 405 and the command type 420 Y may support efficient and reliable beam weight transfer from the DU to the RU (e.g., from an O-DU to an O-RU in an O-RAN system).

The section 405 may include a set of common header fields 410 and one or more format type subsections, such as a format type subsection 425-a, a format type subsection 425-b, a format type subsection 425-c, or any combination of these or additional format type subsections. The set of common header fields 410 may include a section header and a common part of a command header.

The set of common header fields 410 may include the indication of the section type 415 in the section header. For example, the section type 415 field may include a value indicating the section type for the section 405. As illustrated, the section type 415 field may indicate the Section Type 4 for the section 405. The set of common header fields 410 may additionally include an indication of a command type 420 for the Section Type 4 section 405 in the common part of the command header. For example, a section type 4 command type (st4CmdType) field may indicate a command type 420 that is associated with beam weight updating. For example, a command type 420 of 5 (e.g., represented as 0×5) or another value (e.g., Y) may be associated with the beam weight updating. In some examples, the set of common header fields 410 may additionally indicate an acknowledgment request ID 445-a in the common part of the command header. The acknowledgment request ID 445-a may support a feedback mechanism for the Section Type 4 section 405 with the command type 420 Y or, correspondingly, for the message that includes the section 405.

Table 5 illustrates an example format for the set of common header fields 410 of the Section Type 4 section 405 with the command type 420 Y (e.g., 0×5).

TABLE 5
Section Type 4-Example Section Header and Section
Type 4 Common Part of the Command Header
Section Type 4: Slot Level Config
with a Beam Weight Update

| | | | | | | | | Num- | |
|---|---|---|---|---|---|---|---|---|---|
| | | | | | | | | ber | |
| | | | | | | | | of | Octet |
| 0 | 1 | 2 | 3 | 4 | 5 | 6 | 7 | Bytes | Start |

| Transport Header | | | 8 | 1 |
|---|---|---|---|---|
| dataDirection | payloadVersion | scs | 1 | 9 |

| frameId | | 1 | 10 |
|---|---|---|---|
| subframeId | slotId | 1 | 11 |

| | | | |
|---|---|---|---|
| slotId | startSymbolId | 1 | 12 |

| | | | |
|---|---|---|---|
| reserved | cmdScope | 1 | 13 |

| | | |
|---|---|---|
| sectionType = 4 | 1 | 14 |
| numberOfST4Cmds | 1 | 15 |
| reserved | 1 | 16 |
| st4CmdType = 0x5 | 1 | 17 |
| st4CmdLen | 2 | 18 |
| numSlots | 1 | 20 |
| ackNackReqId | 2 | 21 |
| reserved | 2 | 23 |

The message may include a transport header. The section header (e.g., including the common header fields 410) for Section Type 4 associated with a slot level configuration may include a 1-bit dataDirection field, a 3-bit payloadVersion field, a 4-bit subcarrier spacing (scs) field, an 8-bit frameld field, a 4-bit subframe ID field, a 6-bit slotId field, a 6-bit startSymbolId field, reserved bits, or any combination thereof. In some examples, the section header may further include a command scope (cmdScope) field (e.g., spanning 4 bits) that indicates a scope of Section Type 4 commands, a sectionType field (e.g., spanning 8 bits) indicating the section type 415 of 4, a number of section type 4 commands (numberOfST4Cmds) field (e.g., spanning 8 bits) that indicates a quantity of command subsections within the Section Type 4 section 405, or any combination thereof. In some examples, the section 405 may include one format type subsection (or one format type) per command, and the section 405 may include multiple commands to support multiple format type subsections (or multiple format types, where a single command may include multiple format type subsections of the same format type). Accordingly, the quantity of command subsections may in some implementations be equivalent to the quantity of format type subsections. In some other examples, the section 405 may include one or more format type subsections within a single command, such that multiple format type subsections may be included within the same beamforming weight update command type (e.g., command type Y). The Section Type 4 common part of the command header (e.g., including the common header fields 410) may include the st4CmdType field (e.g., spanning 8 bits) indicating the command type 420 of Y (e.g., 5, or 0×5). In some examples, the Section Type 4 common part of the command header may further include a section type 4 command length (st4CmdLen) field (e.g., spanning 16 bits) that indicates the length of the section type 4 command, a number of slots (numSlots) field (e.g., spanning 8 bits) indicating a quantity of slots for which the command configuration is valid, the ackNackReqID field (e.g., spanning 16 bits) indicating the acknowledgment request ID 445-a, reserved bits, or any combination thereof.

Similar to Section Type X, Section Type 4 with the command type Y (e.g., 5, or 0×5) may support one or more format types that support different formats for indicating beam weight parameters. For example, Section Type 4 with the command type Y may support multiple format type subsections of a same format type, of different format types, or both.

In some examples, the section 405 may include a first format type subsection 425-a with Format Type 0. The first format type subsection 425-a may include format type subsection header fields 430-a and format type subsection description fields 450-a. The format type subsection header fields 430-a may indicate the format type 435-a of the first format type subsection 425-a (e.g., Format Type 0). Additionally, in some examples, the format type subsection header fields 430-a may indicate an acknowledgment request ID 445-b for a beam update, a quantity of beams 440-a, n, for the beam update, or both.

The format type subsection description fields 450-a may specify a single beamforming weight compression parameter 455-a and a single beam ID 460-a for the first format type subsection 425-a. Additionally, the format type subsection description fields 450-a may specify sets of beam weight parameters per beam. For example, the single beam ID 460-a may correspond to a first beam (e.g., a base beam), and the first format type subsection 425-a may update beam weights for n beams with consecutive beam IDs starting with the beam ID 460-a (e.g., incrementing by 1 for each beam in the set of communication beams). The bfwCompParam field may indicate a beamforming weight compression parameter 455-a that applies to each beam of the set of communication beams. The format type subsection description fields 450-a may also include a set of beam weight parameters 465-a for the first beam 470-a corresponding to the beam ID 460-a. The format type subsection description fields 450-a may indicate respective sets of beam weight parameters for each beam of the set of communication beams (e.g., the n beams). For example, the format type subsection description fields 450-a may include an n-1 set of beam weight parameters 465-b for the n-1 beam 470-b. The Format Type 0 may support efficiently signaling beam weight updates for beams with contiguous beam IDs and a same beamforming weight compression parameter.

Table 6 illustrates an example format of a Format Type 0 subsection of the Section Type 4 section 405 with the command type 420 Y.

TABLE 6
Section Type 4 with Beam Weight Update Command-
Example Format Type 0 Subsection
Section Type 4: Slot Level Config with a Beam Weight Update

| | | | | | | | | Number | |
|---|---|---|---|---|---|---|---|---|---|
| | | | | | | | | of | Octet |
| 0 | 1 | 2 | 3 | 4 | 5 | 6 | 7 | Bytes | Start |

| Transport Header | | 8 | 1 |
|---|---|---|---|
| Section Type 4 Section Header | | 8 | 9 |
| Section Type 4 common part | | 8 | 17 |
| of the command header | | | |
| formatType = 0 | numBeams | 1 | 25 |

| | | |
|---|---|---|
| numBeams | 1 | 26 |
| BFWformatTypeLen | 2 | 27 |
| bfwCompHdr | 1 | 29 |
| ackNackReqId | 2 | 30 |
| reserved | 1 | 32 |
| bfwCompParam (for next n beams) | var | |
| beamId (for beam 0) | 2 | |
| bfwI (for Antenna 0 and beam 0) | var | |
| bfwQ (for Antenna 0 and beam 0) | var | |
| . . . | | |
| bfwI (for Antenna L-1 and beam 0) | var | |
| bfwQ (for Antenna L-1 and beam 0) | var | |
| . . . | | |
| bfwI (for Antenna 0 and beam n-1) | var | |
| bfwQ (for Antenna 0 and beam n-1) | var | |
| . . . | | |
| bfwI (for Antenna L-1 and beam n-1) | var | |
| bfwQ (for Antenna L-1 and beam n-1) | var | |

In some examples, the section 405 may additionally, or alternatively, include a second format type subsection 425-b with Format Type 1. The second format type subsection 425-b may include format type subsection header fields 430-b and format type subsection description fields 450-b. The format type subsection header fields 430-b may indicate the format type 435-b of the second format type subsection 425-b (e.g., Format Type 1). Additionally, in some examples, the format type subsection header fields 430-b may indicate an acknowledgment request ID 445-c for a beam update, a quantity of beams 440-b, n, for the beam update, or both.

The format type subsection description fields 450-b may specify respective beamforming weight compression parameters and respective beam IDs for each communication beam of the n beams to update. Additionally, the format type subsection description fields 450-b may specify sets of beam weight parameters per beam. For example, the format type subsection description fields 450-b may include a first bfwCompParam field that indicates a first beamforming weight compression parameter 455-b for a first beam 470-c. The format type subsection description fields 450-b may include a first beam ID 460-b corresponding to the first beam 470-c. The format type subsection description fields 450-b may also include a set of beam weight parameters 465-c for the first beam 470-c. The format type subsection description fields 450-b may indicate respective beamforming weight compression parameters, beam IDs, and sets of beam weight parameters for each beam of the set of communication beams (e.g., the n beams). For example, the format type subsection description fields 450-b may include an n-1 bfwCompParam field that indicates a beamforming weight compression parameter 455-c for the n-1 beam 470-d, an n-1 beam ID 460-c corresponding to the n-1 beam 470-d, and an n-1 set of beam weight parameters 465-d for the n-1 beam 470-d. The Format Type 1 may support efficiently signaling beam weight updates for beams with non-contiguous beam IDs, different beamforming weight compression parameters, or both.

Table 7 illustrates an example format of a Format Type 1 subsection of the Section Type 4 section 405 with the command type 420 Y.

TABLE 7
Section Type 4 with Beam Weight Update Command-
Example Format Type 1 Subsection
Section Type 4: Slot Level Config with a Beam Weight Update

| | | | | | | | | Number | |
|---|---|---|---|---|---|---|---|---|---|
| | | | | | | | | of | Octet |
| 0 | 1 | 2 | 3 | 4 | 5 | 6 | 7 | Bytes | Start |

| Transport Header | | 8 | 1 |
|---|---|---|---|
| Section Type 4 Section Header | | 8 | 9 |
| Section Type 4 common part of | | 8 | 17 |
| the command header | | | |
| formatType = 1 | numBeams | 1 | 25 |

| | | |
|---|---|---|
| numBeams | 1 | 26 |
| BFWformatTypeLen | 2 | 27 |
| bfwCompHdr | 1 | 29 |
| ackNackReqId | 2 | 30 |
| reserved | 1 | 32 |
| bfwCompParam (for beam 0) | var | |
| beamId (for beam 0) | 2 | |
| bfwI (for Antenna 0 and beam 0) | var | |
| bfwQ (for Antenna 0 and beam 0) | var | |

. . .

| | |
|---|---|
| bfwI (for Antenna L-1 and beam 0) | var |
| bfwQ (for Antenna L-1 and beam 0) | var |

. . .

| | |
|---|---|
| bfwCompParam (for beam n-1) | var |
| beamId (for beam n-1) | 2 |
| bfwI (for Antenna 0 and beam n-1) | var |
| bfwQ (for Antenna 0 and beam n-1) | var |

. . .

| | |
|---|---|
| bfwI (for Antenna L-1 and beam n-1) | var |
| bfwQ (for Antenna L-1 and beam n-1) | var |

In some examples, the section 405 may additionally, or alternatively, include a third format type subsection 425-c with Format Type 2. The third format type subsection 425-c may include format type subsection header fields 430-c and format type subsection description fields 450-c. The format type subsection header fields 430-c may be similar to, or the same as, the format type subsection header fields 430-a and the format type subsection header fields 430-b. For example, the format type subsection header fields 430-c may indicate the format type 435-c of the third format type subsection 425-c (e.g., Format Type 2). Additionally, in some examples, the format type subsection header fields 430-c may indicate an acknowledgment request ID 445-d for the beam weight update, a quantity of beams 440-c, n, for the beam weight update, or both.

The format type subsection description fields 450-c may specify a single beam ID 460-d for the third format type subsection 425-c, but may specify a beamforming weight compression parameter per beam for the quantity of beams 440-c, n, indicated in the format type subsection header fields 430-c. Additionally, the format type subsection description fields 450-c may specify sets of beam weight parameters per beam. For example, the single beam ID 460-d may correspond to a first beam (e.g., a base beam), and the third format type subsection 425-c may update beam weights for n beams with consecutive beam IDs starting with the beam ID 460-d. The format type subsection description fields 450-c may include a first bfwCompParam field that indicates a first beamforming weight compression parameter 455-d for a first beam 470-e. The format type subsection description fields 450-c may also include a set of beam weight parameters 465-e for the first beam 470-e. The format type subsection description fields 450-c may indicate respective beamforming weight compression parameters and sets of beam weight parameters for each beam of the set of communication beams (e.g., the n beams). For example, the format type subsection description fields 450-c may include an n-1 bfwCompParam field that indicates a beamforming weight compression parameter 455-e for the n-1 beam 470-f and an n-1 set of beam weight parameters 465-f for the n-1 beam 470-f. The Format Type 2 may support efficiently signaling beam weight updates for beams with contiguous beam IDs but with different beamforming weight compression parameters.

Table 8 illustrates an example format of a Format Type 2 subsection of the Section Type 4 section 405 with the command type 420 Y.

TABLE 8
Section Type 4 with Beam Weight Update Command-
Example Format Type 2 Subsection
Section Type 4: Slot Level Config with a Beam Weight Update

| | | | | | | | | Number | |
|---|---|---|---|---|---|---|---|---|---|
| | | | | | | | | of | Octet |
| 0 | 1 | 2 | 3 | 4 | 5 | 6 | 7 | Bytes | Start |

| Transport Header | | 8 | 1 |
|---|---|---|---|
| Section Type 4 Section Header | | 8 | 9 |
| Section Type 4 common part of | | 8 | 17 |
| the command header | | | |
| formatType = 2 | numBeams | 1 | 25 |

| | | |
|---|---|---|
| numBeams | 1 | 26 |
| BFWformatTypeLen | 2 | 27 |
| bfwCompHdr | 1 | 29 |
| ackNackReqId | 2 | 30 |
| reserved | 1 | 32 |
| beamId (for beam 0) | 2 | |
| bfwCompParam (for beam 0) | var | |
| bfwI (for Antenna 0 and beam 0) | var | |
| bfwQ (for Antenna 0 and beam 0) | var | |

. . .

| | |
|---|---|
| bfwI (for Antenna L-1 and beam 0) | var |
| bfwQ (for Antenna L-1 and beam 0) | var |

. . .

| | |
|---|---|
| bfwCompParam (for beam n-1) | var |
| bfwI (for Antenna 0 and beam n-1) | var |
| bfwQ (for Antenna 0 and beam n-1) | var |

. . .

| | |
|---|---|
| bfwI (for Antenna L-1 and beam n-1) | var |
| bfwQ (for Antenna L-1 and beam n-1) | var |

The message formats illustrated by Tables 1 through 8 provide possible message formats that support beam weight transfer from a DU to an RU. However, other message formats may be supported with additional fields, alternative fields, different field sizes, different field orders, or any other format changes that maintain support for indicating beam weight updates.

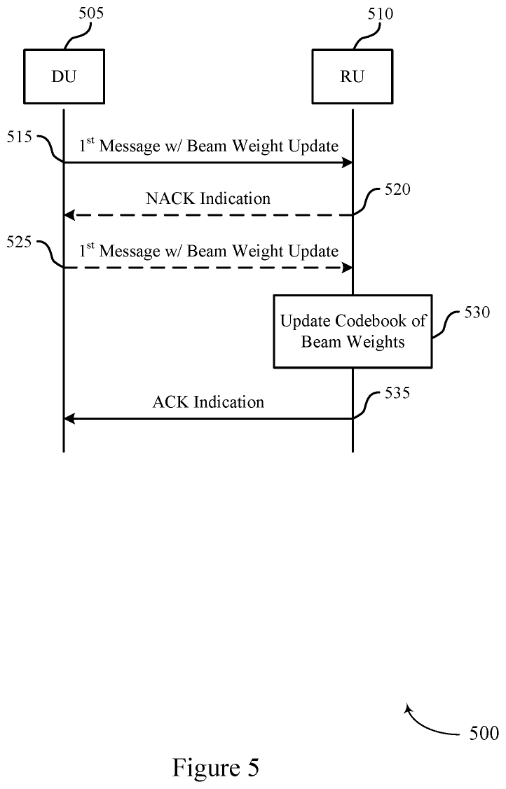

FIG. 5 shows an example of a process flow 500 that supports beam weight transfer from a DU to an RU. The process flow 500 may be performed by aspects of the wireless communication system 100 or the signaling configuration 200, as described herein with reference to FIGS. 1 and 2. For example, a first network entity 105 including a DU 505 and a second network entity 105 including an RU 510 may perform aspects of the process flow 500. The DU 505 may semi-statically or dynamically signal a beam weight update to the RU 510. The DU 505 may be an example of a DU or another network entity 105 as described with reference to FIGS. 1 and 2, and the RU 510 may be an example of an RU or another network entity 105 as described with reference to FIGS. 1 and 2.

In the following description of the process flow 500, operations performed by the DU 505 and the RU 510 may be performed in a different order than is shown. Some operations may be omitted from the process flow 500, and other operations may be added to the process flow 500. Further, although some operations or signaling may be shown to occur at different times for discussion purposes, these operations may occur at the same time. Additionally, or alternatively, other wireless devices may perform aspects of the process flow 500.

At 515, the DU 505 may output (e.g., transmit, send) a first message that indicates a beam weight update. For example, the first message may include a payload that indicates respective sets of beam weight parameters for a set of communication beams and an acknowledgment request ID. The DU 505 may set the acknowledgment request ID (e.g., an ackNackReqId fieId) to a non-zero value to trigger a section type 8 response from the RU 510. In some examples, the DU 505 may set the acknowledgment request ID to zero if the RU 510 reports that the RU 510 is not capable of supporting section type 8 or if the DU 505 selects not to trigger feedback from the RU 510. If the acknowledgment request ID value is set to zero, the RU 510 may not provide ACK/NACK feedback for the first message. The RU 510 may obtain (e.g., receive) the first message.

In some examples, the RU 510 may fail to update a codebook of beam weights at the RU 510 based on the first message. For example, the RU 510 may refrain from updating the codebook based on the respective sets of beam weight parameters for a set of communication beams. In some such examples (e.g., if the acknowledgment request ID value is set to a non-zero value), at 520, the RU 510 may output (e.g., transmit, send), for the DU 505, a second message that indicates unsuccessful application of the respective sets of beam weight parameters for the set of communication beams at the RU 510 based on the acknowledgment request ID. For example, application of the respective sets of beam weight parameters for the set of communication beams at the RU 510 may involve successfully updating the codebook with the updated beam weights.

In some examples, the second message may be a message with a section type 8 section associated with sending ACK/NACK feedback from the RU 510 to the DU 505. The acknowledgment request ID may be for a section type 8 command. The section type 8 section may include a positive acknowledgment ID (ackId) field and a negative acknowledgment ID (nackId) field. The RU 510 may include the acknowledgment request ID corresponding to the first message in the nackId field to indicate that the RU 510 failed to perform the beam weight update indicated by the first message. In some examples, the RU 510 may include ACK/NACK information for multiple messages, multiple fields, multiple beam weight updates, or some combination thereof within a single message with the section type 8 section.

In some implementations, the DU 505 may obtain the second message indicating the NACK for the beam weight update. In some other implementations, the DU 505 may fail to receive a second message indicating an ACK for the beam weight update within a response window (e.g., a time duration). The DU 505 may determine that the beam weight update failed based on not receiving the ACK (e.g., based on the RU 510 failing to successfully receive or process the first message). The DU 505 may selectively determine whether to retransmit the first message indicating the beam weight update based on receiving the NACK (or otherwise not receiving the ACK). In some examples, at 525, the DU 505 may output, for the RU 510, a retransmission of the first message based on the unsuccessful application of the respective sets of beam weight parameters for the set of communication beams at the RU 510. In some implementations, the retransmission of the first message may include the same acknowledgment request ID or a different acknowledgment request ID corresponding to the first message.

At 530, the RU 510 may update the codebook of beam weights based on the respective sets of beam weight parameters for the set of communication beams. At 535, the RU 510 may output, for the DU 505, a second message that indicates successful application of the respective sets of beam weight parameters for the set of communication beams at the RU 510 based on the acknowledgment request ID. For example, the second message may indicate that the RU 510 successfully received the first message, processed the first message, and updated the codebook based on the beam weight update. In some examples, the second message may be a message with a section type 8 section and may include the acknowledgment request ID in the ackId field to indicate that the RU 510 successfully performed the beam weight update indicated by the first message. The DU 505 may obtain the second message that indicates successful application of the respective sets of beam weight parameters for the set of communication beams at the RU 510 and may determine that the RU 510 successfully completed the beam weight update based on the second message.

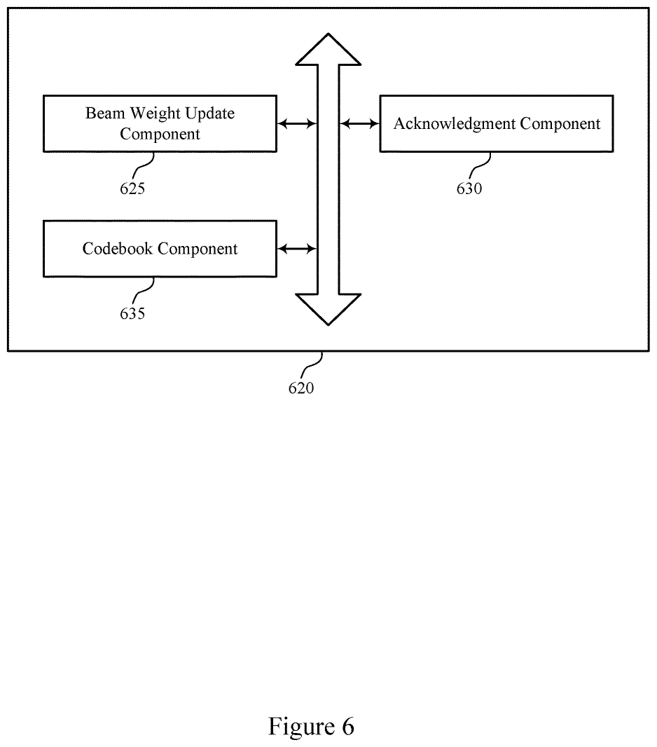

FIG. 6 shows an example of a processing system 620 that supports beam weight transfer from a DU to an RU. The processing system 620 may be an example of a processing system 145 (such as an example or component of a network entity 105) and may include a beam weight update component 625, an acknowledgment component 630, a codebook component 635, or any combination thereof. A processing system 620, or various components thereof, may be an example of means for performing (such as a means for causing a network entity 105 to perform) various techniques described herein.

The beam weight update component 625 may be configured to cause the network entity 105 (e.g., a first network entity including a DU) to output, for an RU, a first message that includes a payload indicating respective sets of beam weight parameters for a set of communication beams and an acknowledgment request identifier. The acknowledgment component 630 may be configured to cause the network entity 105 to obtain a second message that indicates successful or unsuccessful application of the respective sets of beam weight parameters for the set of communication beams at the RU based on the acknowledgment request identifier.

In some examples, the beam weight update component 625 may be configured to cause the network entity 105 to output, for the RU, a retransmission of the first message based on the second message indicating the unsuccessful application of the respective sets of beam weight parameters for the set of communication beams at the RU.

In some examples, the respective sets of beam weight parameters for the set of communication beams includes a respective beamforming weight in-phase value and a respective beamforming weight quadrature-phase value for each antenna of a set of antennas of the RU for each communication beam of the set of communication beams.

In some examples, the first message includes a common header field that indicates a section type value associated with a beam weight update. In some such examples, the payload of the first message is based on the section type value being associated with the beam weight update.

In some other examples, the first message includes a common header field that indicates a section type value of 4 associated with a slot level configuration and a section type 4 command type field that indicates a beam weight update. In some such other examples, the payload of the first message is based on the section type value of 4 being associated with the slot level configuration and the section type 4 command type field indicating the beam weight update.

In some examples, the payload includes a first format type subsection that indicates a quantity of beams of the set of communication beams, a beamform weight compression parameter for the set of communication beams, and a beam identifier indicating a first communication beam of the set of communication beams.

In some examples, the payload includes a second format type subsection that indicates a quantity of beams of the set of communication beams, respective beam identifiers for each communication beam of the set of communication beams, and respective beamforming weight compression parameters for each communication beam of the set of communication beams.

In some examples, the payload includes a third format type subsection that indicates a quantity of beams of the set of communication beams, a beam identifier indicating a first communication beam of the set of communication beams, and respective beamforming weight compression parameters for each communication beam of the set of communication beams.

In some examples, the payload includes a format type 0 subsection, a format type 1 subsection, a format type 2 subsection, or a combination thereof.

In some examples, the acknowledgment request identifier is associated with the first message. In some such examples, the second message includes the acknowledgment request identifier as a positive acknowledgment identifier to acknowledge, for the first message, the successful application of the respective sets of beam weight parameters for the set of communication beams at the RU or a negative acknowledgment identifier to acknowledge, for the first message, the unsuccessful application of the respective sets of beam weight parameters for the set of communication beams at the RU.

In some examples, the payload indicates a set of multiple acknowledgment request identifiers associated with a set of multiple format type subsections, the acknowledgment request identifier being associated with a first format type subsection of the set of multiple format type subsections. In some such examples, the second message includes the set of multiple acknowledgment request identifiers as positive acknowledgment identifiers to acknowledge, for the first message, the successful application of the respective sets of beam weight parameters for the set of communication beams at the RU, or negative acknowledgment identifiers to acknowledge, for the first message, the unsuccessful application of the respective sets of beam weight parameters for the set of communication beams at the RU.

In some examples, the second message includes a common header field that indicates a section type value of 8 associated with positive acknowledgment/negative acknowledgment feedback.

In some examples, the RU is associated with an O-RAN system. In some examples, the first network entity includes a DU associated with the O-RAN system.

In some examples, the beam weight update component 625 may be configured to cause the network entity 105 (e.g., a second network entity 105 including an RU) to obtain a first message that includes a payload indicating respective sets of beam weight parameters for a set of communication beams and an acknowledgment request identifier. In some examples, the acknowledgment component 630 may be configured to cause the network entity 105 to output, for a DU, a second message that indicates successful or unsuccessful application of the respective sets of beam weight parameters for the set of communication beams at the second network entity based on the acknowledgment request identifier.

In some examples, the codebook component 635 may be configured to cause the network entity 105 to update a codebook of beam weights based on the respective sets of beam weight parameters for the set of communication beams, where the second message indicates the successful application of the respective sets of beam weight parameters for the set of communication beams at the second network entity based on the updating the codebook.

In some examples, the codebook component 635 may be configured to cause the network entity 105 to refrain from updating a codebook of beam weights based on the respective sets of beam weight parameters for the set of communication beams, where the second message indicates the unsuccessful application of the respective sets of beam weight parameters for the set of communication beams at the second network entity based on the refraining from updating the codebook. In some examples, the beam weight update component 625 may be configured to cause the network entity 105 to obtain a retransmission of the first message based on the second message indicating the unsuccessful application of the respective sets of beam weight parameters for the set of communication beams at the second network entity.

In some examples, the respective sets of beam weight parameters for the set of communication beams includes a respective beamforming weight in-phase value and a respective beamforming weight quadrature-phase value for each antenna of a set of antennas of the second network entity for each communication beam of the set of communication beams.

In some examples, the first message includes a common header field that indicates a section type value associated with a beam weight update. In some such examples, the payload of the first message is based on the section type value being associated with the beam weight update.

In some other examples, the first message includes a common header field that indicates a section type value of 4 associated with a slot level configuration and a section type 4 command type field that indicates a beam weight update. In some such other examples, the payload of the first message is based on the section type value of 4 being associated with the slot level configuration and the section type 4 command type field indicating the beam weight update.

In some examples, the payload includes a first format type subsection that indicates a quantity of beams of the set of communication beams, a beamform weight compression parameter for the set of communication beams, and a beam identifier indicating a first communication beam of the set of communication beams.

In some examples, the payload includes a second format type subsection that indicates a quantity of beams of the set of communication beams, respective beam identifiers for each communication beam of the set of communication beams, and respective beamforming weight compression parameters for each communication beam of the set of communication beams.

In some examples, the payload includes a third format type subsection that indicates a quantity of beams of the set of communication beams, a beam identifier indicating a first communication beam of the set of communication beams, and respective beamforming weight compression parameters for each communication beam of the set of communication beams.

In some examples, the payload includes a format type 0 subsection, a format type 1 subsection, a format type 2 subsection, or a combination thereof.

In some examples, the acknowledgment request identifier is associated with the first message. In some such examples, the second message includes the acknowledgment request identifier as a positive acknowledgment identifier to acknowledge, for the first message, the successful application of the respective sets of beam weight parameters for the set of communication beams at the second network entity or a negative acknowledgment identifier to acknowledge, for the first message, the unsuccessful application of the respective sets of beam weight parameters for the set of communication beams at the second network entity.

In some other examples, the payload indicates a set of multiple acknowledgment request identifiers associated with a set of multiple format type subsections, the acknowledgment request identifier being associated with a first format type subsection of the set of multiple format type subsections. In some such examples, the second message includes the set of multiple acknowledgment request identifiers as positive acknowledgment identifiers to acknowledge, for the first message, the successful application of the respective sets of beam weight parameters for the set of communication beams at the second network entity or negative acknowledgment identifiers to acknowledge, for the first message, the unsuccessful application of the respective sets of beam weight parameters for the set of communication beams at the second network entity.

In some examples, the second message includes a common header field that indicates a section type value of 8 associated with positive acknowledgment/negative acknowledgment feedback.

In some examples, the DU is associated with an O-RAN system. In some examples, the second network entity includes an RU associated with the O-RAN system.

A processing system 620 may include or be an example of one or more chips, systems-on-a-chip (SoCs), chipsets, packages, components, or devices that individually or collectively constitute or include a processing system. The processing system 620 may interface with other components of a network entity 105. For example, operations described with reference to a processing system 620, or various components thereof, may be performed by or with other such components, including a receiver, a transmitter, a transceiver, a modem, a user interface, a modulator/demodulator, an encoder/decoder, or any combination thereof (such as of the processing system 620, coupled with the processing system 620, of a network entity 105). Operations described herein with reference to the processing system 620, or various components thereof, may be performed by or with other such components, including a CU 160, a DU 165, an RU 170, or any combination thereof. Each of one or more of any of such components, or subcomponents thereof (such as one or more processors, one or more memories), may communicate, directly or indirectly, with one another. Communications may include communication within a protocol layer of a protocol stack, communication associated with a logical channel of a protocol stack (such as between protocol layers of a protocol stack, within a device, component, or virtualized component associated with a network entity 105, between devices, components, or virtualized components associated with a network entity 105), or any combination thereof.

By including or configuring a processing system 620 for operation as described herein, the processing system 620 may support techniques for improved communication reliability, reduced latency, reduced signaling overhead, improved coordination between devices, or any combination thereof.

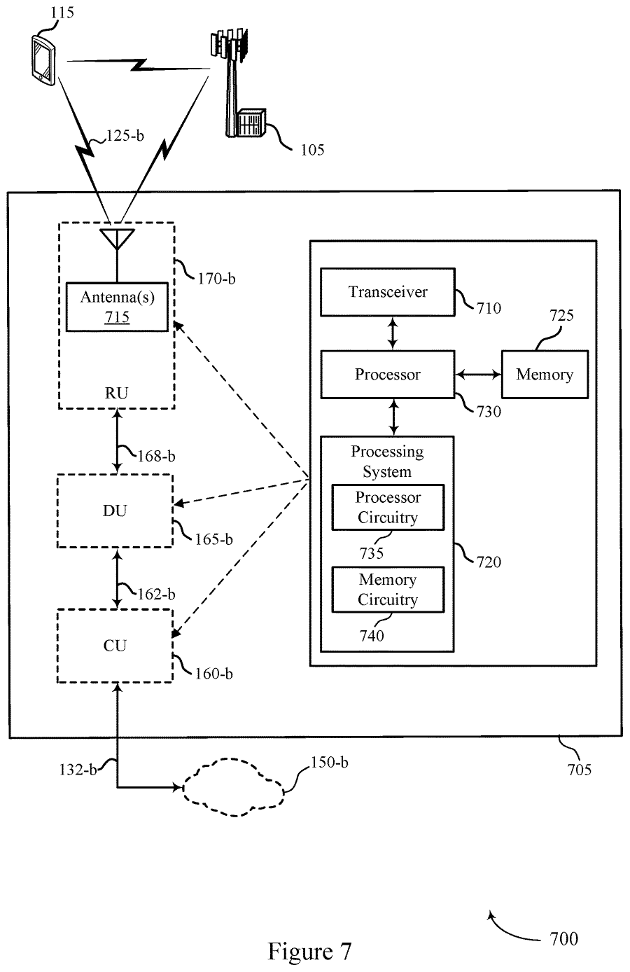

FIG. 7 shows an example of a system 700 including a device 705 that supports beam weight transfer from a DU to an RU. The device 705 may communicate (such as via one or more wired interfaces or one or more wireless interfaces) with other network devices or network equipment such as a core network 150-b, other network entities 105, UEs 115, or any combination thereof. The device 705 may include components for transmitting and receiving communications, which may include a processing system 720, a transceiver 710, antenna(s) 715, a memory 725, and a processor 730. Components of the device 705 may be coupled (such as operatively, communicatively, functionally, electronically, electrically, in electronic communication) via one or more interfaces.

The transceiver 710 may communicate bi-directionally with another transceiver via wired or wireless links and may support transmission operations, reception operations, or both, as described herein. The transceiver 710 may include a modem to modulate and demodulate signals, to provide the modulated signals for transmission (such as via antenna(s) 715, via a wired interface), and to demodulate received signals (such as received via antenna(s) 715, received via a wired interface). The transceiver 710 may be operable to support communications via one or more communication links (such as a communication link 125-b, a backhaul link 132-b, a midhaul link 162-b, a fronthaul link 168-b, or any combination thereof).

The processor 730 may be a general-purpose processing component that supports various operations (such as applications) of the device 705. The memory 725 may be a general-purpose storage component that stores code executable by the processor 730. Such code may include instructions that, when executed by the processor 730, cause the device 705 to perform various functions (such as to support an application of the device 705).

For examples in which the device 705 is a network entity 105 in a disaggregated architecture, one or more components of the device 705 may be located at one or more of a CU 160-b, a DU 165-b, or an RU 170-b, one or more of which may include aspects of the processing system 720, the processor 730, the memory 725, or the transceiver 710. Functions of the device 705 may be performed at different components or an operation may be divided between different components (such as different functions being supported by aspects of the CU 160-b, the DU 165-b, or the RU 170-b, the transceiver 710, the processor 730, the memory 725, the processing system 720, or any combination thereof). For example, the processing system 720 may be a component of one or more of the CU 160-b, the DU 165-b, or the RU 170-b. In some examples, interfaces between components of device 705 (such as the CU 160-b, the DU 165-b, or the RU 170-b) may support communication at a protocol layer or between protocol layers of a protocol stack.

In some examples, the processing system 720 may manage aspects of communication with the core network 150-b (such as via a backhaul link 132). For example, the processing system 720 may manage the transfer of data communication for UEs 115 with a gateway of the core network 150-b. In some examples, the processing system 720 may manage communication with one or more other network entities 105 and may include a controller or scheduler for controlling communication with UEs 115 (such as in cooperation with the one or more other network entities 105). In some examples, the processing system 720 may support an interface (such as an X2 interface or an Xn interface) to provide communication between network entities 105.

The processing system 720 may be an example of a processing system 145 or a processing system 620. For example, the processing system 720 may include processor circuitry 735 and memory circuitry 740 that stores code, and the processing system 720 may be configured to cause the device 705 to perform operations that support beam weight transfer from a DU to an RU. Although the processing system 720 is illustrated as a separate component, which may involve a separate chip, chipset, or other module, in some implementations, one or more functions described with reference to the processing system 720 may be supported by or performed by a transceiver 710, antenna(s) 715, a processor 730, memory 725, or any combination thereof, such that a processing system 720 may include one or more of a transceiver 710, antenna(s) 715, a processor 730, memory 725, or any combination thereof. Further, processor circuitry 735 and memory circuitry 740 each may be implemented at the device 705 in accordance with an aggregated architecture, or the processor circuitry 735 and the memory circuitry 740 may be implemented at one or more of a CU 160-b, a DU 165-b, or an RU 170-b in accordance with a disaggregated architecture.

By including or configuring the processing system 720 for operation in the device 705 as described herein, the device 705 may support techniques for improved communication reliability, reduced latency, reduced signaling overhead, improved coordination between devices, or any combination thereof.

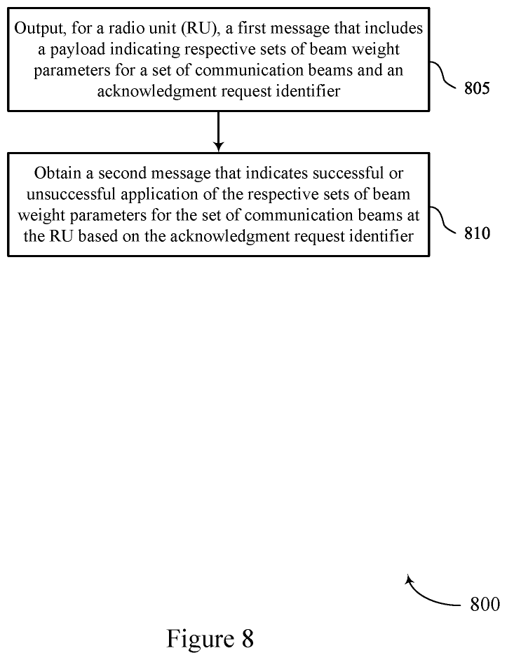

FIG. 8 shows an example of a method 800 that supports beam weight transfer from a DU to an RU. Operations of the method 800 may be performed by a first network entity 105 or its components (such as using a processing system configured to cause the network entity to perform one or more operations) as described herein. The first network entity 105 may include a DU.

At 805, the method may include outputting, for an RU, a first message that includes a payload indicating respective sets of beam weight parameters for a set of communication beams and an acknowledgment request identifier. In some examples, aspects of the operations of 805 may be performed by a beam weight update component 625.

At 810, the method may include obtaining a second message that indicates successful or unsuccessful application of the respective sets of beam weight parameters for the set of communication beams at the RU based on the acknowledgment request identifier. In some examples, aspects of the operations of 810 may be performed by an acknowledgment component 630.

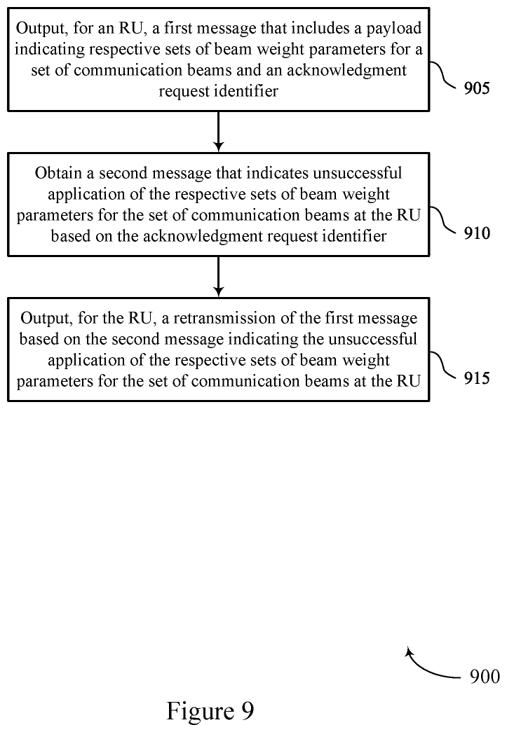

FIG. 9 shows an example of a method 900 that supports beam weight transfer from a DU to an RU. Operations of the method 900 may be performed by a first network entity 105 or its components (such as using a processing system configured to cause the network entity to perform one or more operations) as described herein. The first network entity 105 may include a DU.

At 905, the method may include outputting, for an RU, a first message that includes a payload indicating respective sets of beam weight parameters for a set of communication beams and an acknowledgment request identifier. In some examples, aspects of the operations of 905 may be performed by a beam weight update component 625.

At 910, the method may include obtaining a second message that indicates unsuccessful application of the respective sets of beam weight parameters for the set of communication beams at the RU based on the acknowledgment request identifier. In some examples, aspects of the operations of 910 may be performed by an acknowledgment component 630.

At 915, the method may include outputting, for the RU, a retransmission of the first message based on the second message indicating the unsuccessful application of the respective sets of beam weight parameters for the set of communication beams at the RU. In some examples, aspects of the operations of 915 may be performed by a beam weight update component 625.

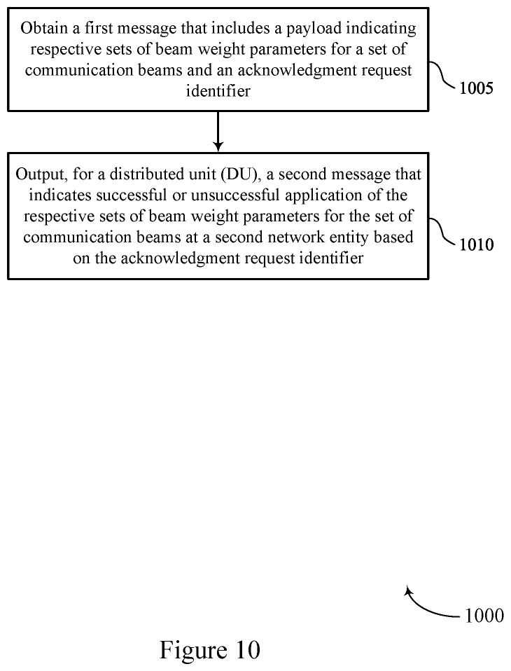

FIG. 10 shows an example of a method 1000 that supports beam weight transfer from a DU to an RU. Operations of the method 1000 may be performed by a second network entity 105 or its components (such as using a processing system configured to cause the network entity to perform one or more operations) as described herein. The second network entity 105 may include an RU.

At 1005, the method may include obtaining a first message that includes a payload indicating respective sets of beam weight parameters for a set of communication beams and an acknowledgment request identifier. In some examples, aspects of the operations of 1005 may be performed by a beam weight update component 625.

At 1010, the method may include outputting, for a DU, a second message that indicates successful or unsuccessful application of the respective sets of beam weight parameters for the set of communication beams at the second network entity based on the acknowledgment request identifier. In some examples, aspects of the operations of 1010 may be performed by an acknowledgment component 630.

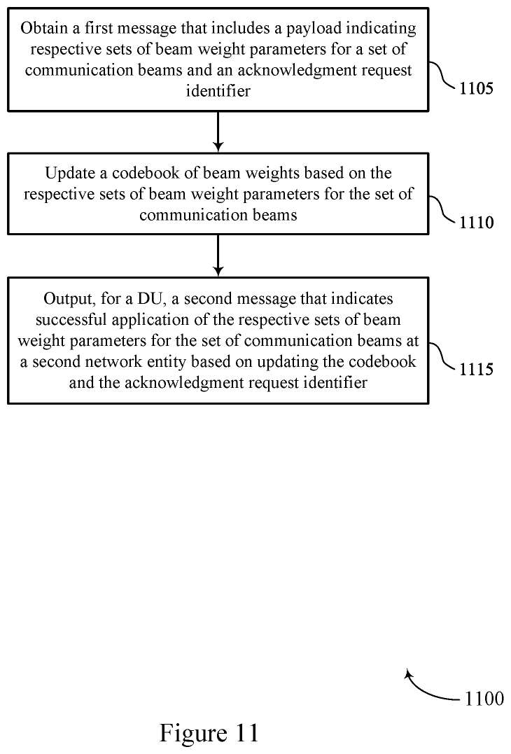

FIG. 11 shows an example of a method 1100 that supports beam weight transfer from a DU to an RU. Operations of the method 1100 may be performed by a second network entity 105 or its components (such as using a processing system configured to cause the network entity to perform one or more operations) as described herein. The second network entity 105 may include an RU.

At 1105, the method may include obtaining a first message that includes a payload indicating respective sets of beam weight parameters for a set of communication beams and an acknowledgment request identifier. In some examples, aspects of the operations of 1105 may be performed by a beam weight update component 625.

At 1110, the method may include updating a codebook of beam weights based on the respective sets of beam weight parameters for the set of communication beams. In some examples, aspects of the operations of 1110 may be performed by a codebook component 635.

At 1115, the method may include outputting, for a DU, a second message that indicates successful application of the respective sets of beam weight parameters for the set of communication beams at the second network entity based on updating the codebook and the acknowledgment request identifier. In some examples, aspects of the operations of 1115 may be performed by an acknowledgment component 630.

Implementation examples are described in the following numbered clauses:
Aspect 1: A method for wireless communication at a first network entity, comprising: outputting, for an RU, a first message that comprises a payload indicating: respective sets of beam weight parameters for a set of communication beams, and an acknowledgment request identifier; and obtaining a second message that indicates successful or unsuccessful application of the respective sets of beam weight parameters for the set of communication beams at the RU based at least in part on the acknowledgment request identifier.

Aspect 2: The method of aspect 1, further comprising: outputting, for the RU, a retransmission of the first message based at least in part on the second message indicating the unsuccessful application of the respective sets of beam weight parameters for the set of communication beams at the RU.

Aspect 3: The method of either of aspects 1 or 2, wherein the respective sets of beam weight parameters for the set of communication beams comprises a respective beamforming weight in-phase value and a respective beamforming weight quadrature-phase value for each antenna of a set of antennas of the RU for each communication beam of the set of communication beams.

Aspect 4: The method of any of aspects 1 through 3, wherein the first message comprises a common header field that indicates a section type value associated with a beam weight update; and the payload of the first message is based at least in part on the section type value being associated with the beam weight update.

Aspect 5: The method of any of aspects 1 through 3, wherein the first message comprises: a common header field that indicates a section type value of 4 associated with a slot level configuration, and a section type 4 command type field that indicates a beam weight update; and the payload of the first message is based at least in part on the section type value of 4 being associated with the slot level configuration and the section type 4 command type field indicating the beam weight update.

Aspect 6: The method of any of aspects 1 through 5, wherein the payload comprises a first format type subsection that indicates: a quantity of beams of the set of communication beams, a beamforming weight compression parameter for the set of communication beams, and a beam identifier indicating a first communication beam of the set of communication beams.

Aspect 7: The method of any of aspects 1 through 6, wherein the payload comprises a second format type subsection that indicates: a quantity of beams of the set of communication beams, respective beam identifiers for each communication beam of the set of communication beams, and respective beamforming weight compression parameters for each communication beam of the set of communication beams.

Aspect 8: The method of any of aspects 1 through 7, wherein the payload comprises a third format type subsection that indicates: a quantity of beams of the set of communication beams, a beam identifier indicating a first communication beam of the set of communication beams, and respective beamforming weight compression parameters for each communication beam of the set of communication beams.

Aspect 9: The method of any of aspects 1 through 8, wherein the payload comprises a format type 0 subsection, a format type 1 subsection, a format type 2 subsection, or a combination thereof.

Aspect 10: The method of any of aspects 1 through 9, wherein the acknowledgment request identifier is associated with the first message; and the second message comprises the acknowledgment request identifier as: a positive acknowledgment identifier to acknowledge, for the first message, the successful application of the respective sets of beam weight parameters for the set of communication beams at the RU, or a negative acknowledgment identifier to acknowledge, for the first message, the unsuccessful application of the respective sets of beam weight parameters for the set of communication beams at the RU.

Aspect 11: The method of any of aspects 1 through 9, wherein the payload indicates a plurality of acknowledgment request identifiers associated with a plurality of format type subsections, the acknowledgment request identifier being associated with a first format type subsection of the plurality of format type subsections; and the second message comprises the plurality of acknowledgment request identifiers as: positive acknowledgment identifiers to acknowledge, for the first message, the successful application of the respective sets of beam weight parameters for the set of communication beams at the RU, or negative acknowledgment identifiers to acknowledge, for the first message, the unsuccessful application of the respective sets of beam weight parameters for the set of communication beams at the RU.

Aspect 12: The method of any of aspects 1 through 11, wherein the second message comprises a common header field that indicates a section type value of 8 associated with positive acknowledgment/negative acknowledgment feedback.

Aspect 13: The method of any of aspects 1 through 12, wherein the RU is associated with an O-RAN system; and the first network entity comprises a DU associated with the O-RAN system.

Aspect 14: A method for wireless communication at a second network entity, comprising: obtaining a first message that comprises a payload indicating: respective sets of beam weight parameters for a set of communication beams, and an acknowledgment request identifier; and outputting, for a DU, a second message that indicates successful or unsuccessful application of the respective sets of beam weight parameters for the set of communication beams at the second network entity based at least in part on the acknowledgment request identifier.

Aspect 15: The method of aspect 14, further comprising: updating a codebook of beam weights based at least in part on the respective sets of beam weight parameters for the set of communication beams, wherein the second message indicates the successful application of the respective sets of beam weight parameters for the set of communication beams at the second network entity based at least in part on the updating the codebook.

Aspect 16: The method of aspect 14, further comprising: refraining from updating a codebook of beam weights based at least in part on the respective sets of beam weight parameters for the set of communication beams, wherein the second message indicates the unsuccessful application of the respective sets of beam weight parameters for the set of communication beams at the second network entity based at least in part on the refraining from updating the codebook; and obtaining a retransmission of the first message based at least in part on the second message indicating the unsuccessful application of the respective sets of beam weight parameters for the set of communication beams at the second network entity.

Aspect 17: The method of any of aspects 14 through 16, wherein the respective sets of beam weight parameters for the set of communication beams comprises a respective beamforming weight in-phase value and a respective beamforming weight quadrature-phase value for each antenna of a set of antennas of the second network entity for each communication beam of the set of communication beams.

Aspect 18: The method of any of aspects 14 through 17, wherein the first message comprises a common header field that indicates a section type value associated with a beam weight update; and the payload of the first message is based at least in part on the section type value being associated with the beam weight update.

Aspect 19: The method of any of aspects 14 through 17, wherein the first message comprises: a common header field that indicates a section type value of 4 associated with a slot level configuration, and a section type 4 command type field that indicates a beam weight update; and the payload of the first message is based at least in part on the section type value of 4 being associated with the slot level configuration and the section type 4 command type field indicating the beam weight update.

Aspect 20: The method of any of aspects 14 through 19, wherein the payload comprises a first format type subsection that indicates: a quantity of beams of the set of communication beams, a beamforming weight compression parameter for the set of communication beams, and a beam identifier indicating a first communication beam of the set of communication beams.

Aspect 21: The method of any of aspects 14 through 20, wherein the payload comprises a second format type subsection that indicates: a quantity of beams of the set of communication beams, respective beam identifiers for each communication beam of the set of communication beams, and respective beamforming weight compression parameters for each communication beam of the set of communication beams.

Aspect 22: The method of any of aspects 14 through 21, wherein the payload comprises a third format type subsection that indicates: a quantity of beams of the set of communication beams, a beam identifier indicating a first communication beam of the set of communication beams, and respective beamforming weight compression parameters for each communication beam of the set of communication beams.

Aspect 23: The method of any of aspects 14 through 22, wherein the payload comprises a format type 0 subsection, a format type 1 subsection, a format type 2 subsection, or a combination thereof.

Aspect 24: The method of any of aspects 14 through 23, wherein the acknowledgment request identifier is associated with the first message; and the second message comprises the acknowledgment request identifier as: a positive acknowledgment identifier to acknowledge, for the first message, the successful application of the respective sets of beam weight parameters for the set of communication beams at the second network entity, or a negative acknowledgment identifier to acknowledge, for the first message, the unsuccessful application of the respective sets of beam weight parameters for the set of communication beams at the second network entity.

Aspect 25: The method of any of aspects 14 through 23, wherein the payload indicates a plurality of acknowledgment request identifiers associated with a plurality of format type subsections, the acknowledgment request identifier being associated with a first format type subsection of the plurality of format type subsections; and the second message comprises the plurality of acknowledgment request identifiers as: positive acknowledgment identifiers to acknowledge, for the first message, the successful application of the respective sets of beam weight parameters for the set of communication beams at the second network entity, or negative acknowledgment identifiers to acknowledge, for the first message, the unsuccessful application of the respective sets of beam weight parameters for the set of communication beams at the second network entity.

Aspect 26: The method of any of aspects 14 through 25, wherein the second message comprises a common header field that indicates a section type value of 8 associated with positive acknowledgment/negative acknowledgment feedback.

Aspect 27: The method of any of aspects 14 through 26, wherein the DU is associated with an O-RAN system; and the second network entity comprises an RU associated with the O-RAN system.

Aspect 28: A first network entity, comprising a processing system that includes processor circuitry and memory circuitry that stores code, the processing system configured to cause the first network entity to perform a method of any of aspects 1 through 13.

Aspect 29: A first network entity for wireless communication, comprising at least one means for performing a method of any of aspects 1 through 13.

Aspect 30: A non-transitory computer-readable medium storing code for wireless communication, the code comprising instructions executable by one or more processors to perform a method of any of aspects 1 through 13.

Aspect 31: A second network entity, comprising a processing system that includes processor circuitry and memory circuitry that stores code, the processing system configured to cause the second network entity to perform a method of any of aspects 14 through 27.

Aspect 32: A second network entity for wireless communication, comprising at least one means for performing a method of any of aspects 14 through 27.

Aspect 33: A non-transitory computer-readable medium storing code for wireless communication, the code comprising instructions executable by one or more processors to perform a method of any of aspects 14 through 27.

It should be noted that methods described herein describe possible implementations. Other implementations in accordance with the described techniques are possible, including implementations in which operations are rearranged or otherwise modified relative to the described methods. Further, aspects from two or more of the described methods may be combined.

Although aspects of 5G or 6G systems may be described for purposes of example and corresponding terminology may be used in the description, the techniques described herein are applicable beyond 5G, or 6G networks. For example, the described techniques may be applicable to other communication systems such as Institute of Electrical and Electronics Engineers (IEEE) 802.11 (Wi-Fi), IEEE 802.20, Flash-OFDM, or other systems and radio technologies not explicitly mentioned herein.

As used herein, a processing system (such as a processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform functions or operations described herein. A group of processors collectively configurable or configured to cause a device to perform a set of functions may include a first processor configured to cause the device to perform a first function of the set and a second processor configured to cause the device to perform a second function of the set. In some other examples, each of a group of processors may be configured to cause a device to perform a same set of functions.

As used herein, a processing system (such as a processing system 145) also includes memory circuitry in the form of one or multiple memory devices, memory blocks, memory elements, or other discrete gate or transistor logic or circuitry, each of which may include or implement tangible storage media such as random-access memory (RAM) or read-only memory (ROM), or combinations thereof (any one or more of which may be generally referred to herein individually as a “memory” or collectively as “the memory” or “the memory circuitry”). One or more of the memories may be coupled (such as operatively, communicatively, electronically, electrically) with one or more processors of the processor circuitry and may individually or collectively store processor-executable code or instructions (such as software) that, when executed by one or more of the processors, may cause a device (such as configure the device, using one or more of the processors) to perform functions or operations described herein. Additionally, or alternatively, in some examples, one or more of the processors may be configured to cause a device to perform functions or operations described herein without requiring configuration by software. As used herein, “software” shall be construed to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

As used herein, a processing system (such as a processing system 145) may include or be coupled with one or more modems (such as a cellular modem, a 5G-compliant modem, a 6G-compliant modem). In some examples, one or more processors of a processing system may include or implement one or more of the modems. A processing system also may include or be coupled with multiple radios (collectively “the radio”), multiple RF chains, or multiple transceivers, each of which may in turn be coupled with one or more of multiple antennas. In some examples, one or more processors of a processing system may include or implement one or more of the radios, RF chains, or transceivers. An RF chain may include one or more filters, mixers, oscillators, amplifiers, analog-to-digital converters (ADCs), or other devices that convert between an analog signal (such as for transmission or reception via an air interface) and a digital signal (such as for processing by processor circuitry).

As described herein, being “configured to,” being “configurable to,” and being “operable to” may be used interchangeably and may be associated with a capability, when executing code (such as processor-executable code, instructions) stored in memory circuitry (such as a non-transitory computer-readable medium, of the memory circuitry, storing code for wireless communication that is executable by a processing system) or otherwise, to perform one or more of the functions described herein.

As used herein, the term “determine” or “determining” can encompass one or more of a variety of actions. For example, “determining” can include one or more of calculating, computing, processing, deriving, detecting, estimating, looking up, inferring, ascertaining, measuring, resolving, selecting, obtaining, identifying, interpreting, demodulating, decoding, reading, establishing, forming, or generating, among other examples. In some such examples, determining can involve a processing system performing some type of calculating, computing, deriving, estimating, inferring, ascertaining, resolving, predicting, or other processing to obtain one or more numerical values, sets, elements, or other information or results. In some such examples, determining can involve a processing system identifying, looking up, investigating or otherwise obtaining some type of value, set, element, or other information or result from a table, data structure, database, or an implementation of memory, such as from a larger set of values, sets, or elements or other information or results. In some such examples, determining can involve a processing system identifying, interpreting, demodulating, decoding, detecting, reading, or otherwise obtaining some type of value, set, element, or other information or result signaled in, for example, a received wireless signal. In some such examples, determining can involve a processing system performing a measurement, such as on a received signal.

As used herein, a phrase referring to “at least one of” or “one or more of”′ a list of items refers to any combination of those items, including single members. For example, “at least one of: a, b, or c” is intended to cover: a, b, c, a-b, a-c, b-c, and a-b-c. Additionally, as used herein, a phrase referring to “a” or “an” element refers to one or more of such elements acting individually or collectively to perform the recited function(s). Thus, the terms “a,” “at least one,” “one or more,” and “at least one of one or more” may be interchangeable. For instance, for a claim that refers to “a” component performing one or more functions, each of the individual functions may be performed by a single component or by any combination of multiple components, and subsequent reference to a component introduced with the article “a” using the term “the” may refer to any or all of the single or multiple components. Thus, a component introduced with the article “a” may be understood to mean “one or more” components, and referring to “the” component subsequently in the claims may be understood to be equivalent to referring to “at least one of the one or more” components. Additionally, as used herein, a “set” can refer to one or more items, and a “subset” can refer to a whole set or less than the whole set, but not an empty set. Additionally, as used herein, the term “or” is intended to be interpreted in the inclusive sense, such as when referring to a series, and may be used interchangeably with the term “and/or,” unless otherwise explicitly indicated (for example, if used in conjunction with “either” or “only one of”). For example, “a or b” may include a only, b only, or a combination of a and b.

The disclosure is provided to enable a person having ordinary skill in the art to implement the described techniques. Modifications to the disclosure will be apparent to a person having ordinary skill in the art, and the techniques disclosed herein may be applied with other variations without departing from the scope of the disclosure. Thus, the disclosure is not limited to the examples and designs described herein but is to be accorded the broadest scope consistent with the principles and novel features disclosed herein.

What is claimed is:

1. A first network entity, comprising:
a processing system that includes processor circuitry and memory circuitry that stores code, the processing system configured to cause the first network entity to:
transmit, for a radio unit (RU), a first message that comprises a payload indicating:
respective sets of beam weight parameters for a set of communication beams, and
an acknowledgment request identifier; and
receive a second message that indicates successful or unsuccessful application of the respective sets of beam weight parameters for the set of communication beams at the RU based at least in part on the acknowledgment request identifier.

2. The first network entity of claim 1, wherein the processing system is further configured to cause the first network entity to:
transmit, for the RU, a retransmission of the first message based at least in part on the second message indicating the unsuccessful application of the respective sets of beam weight parameters for the set of communication beams at the RU.

3. The first network entity of claim 1, wherein the respective sets of beam weight parameters for the set of communication beams comprises a respective beamforming weight in-phase value and a respective beamforming weight quadrature-phase value for each antenna of a set of antennas of the RU for each communication beam of the set of communication beams.

4. The first network entity of claim 1, wherein:
the first message comprises a common header field that indicates a section type value associated with a beam weight update; and
the payload of the first message is based at least in part on the section type value being associated with the beam weight update.

5. The first network entity of claim 1, wherein:
the first message comprises:
a common header field that indicates a section type value of 4 associated with a slot level configuration, and
a section type 4 command type field that indicates a beam weight update; and
the payload of the first message is based at least in part on the section type value of 4 being associated with the slot level configuration and the section type 4 command type field indicating the beam weight update.

6. The first network entity of claim 1, wherein the payload comprises a first format type subsection that indicates:
a quantity of beams of the set of communication beams,
a beamform weight compression parameter for the set of communication beams, and
a beam identifier indicating a first communication beam of the set of communication beams.

7. The first network entity of claim 1, wherein the payload comprises a second format type subsection that indicates:
a quantity of beams of the set of communication beams,
respective beam identifiers for each communication beam of the set of communication beams, and
respective beamforming weight compression parameters for each communication beam of the set of communication beams.

8. The first network entity of claim 1, wherein the payload comprises a third format type subsection that indicates:
a quantity of beams of the set of communication beams,
a beam identifier indicating a first communication beam of the set of communication beams, and
respective beamforming weight compression parameters for each communication beam of the set of communication beams.

9. The first network entity of claim 1, wherein the payload comprises a format type 0 subsection, a format type 1 subsection, a format type 2 subsection, or a combination thereof.

10. The first network entity of claim 1, wherein:
the acknowledgment request identifier is associated with the first message; and
the second message comprises the acknowledgment request identifier as:
a positive acknowledgment identifier to acknowledge, for the first message, the successful application of the respective sets of beam weight parameters for the set of communication beams at the RU, or
a negative acknowledgment identifier to acknowledge, for the first message, the unsuccessful application of the respective sets of beam weight parameters for the set of communication beams at the RU.

11. The first network entity of claim 1, wherein:
the payload indicates a plurality of acknowledgment request identifiers associated with a plurality of format type subsections, the acknowledgment request identifier being associated with a first format type subsection of the plurality of format type subsections; and
the second message comprises the plurality of acknowledgment request identifiers as:
positive acknowledgment identifiers to acknowledge, for the first message, the successful application of the respective sets of beam weight parameters for the set of communication beams at the RU, or
negative acknowledgment identifiers to acknowledge, for the first message, the unsuccessful application of the respective sets of beam weight parameters for the set of communication beams at the RU.

12. The first network entity of claim 1, wherein the second message comprises a common header field that indicates a section type value of 8 associated with positive acknowledgment/negative acknowledgment feedback.

13. The first network entity of claim 1, wherein:
the RU is associated with an open radio access network (O-RAN) system; and
the first network entity comprises a distributed unit (DU) associated with the O-RAN system.

14. A method for wireless communication at a first network entity, comprising:
transmitting, for a radio unit (RU), a first message that comprises a payload indicating:
respective sets of beam weight parameters for a set of communication beams, and
an acknowledgment request identifier; and
receiving a second message that indicates successful or unsuccessful application of the respective sets of beam weight parameters for the set of communication beams at the RU based at least in part on the acknowledgment request identifier.

15. The method of claim 14, further comprising:
transmitting, for the RU, a retransmission of the first message based at least in part on the second message indicating the unsuccessful application of the respective sets of beam weight parameters for the set of communication beams at the RU.

16. The method of claim 14, wherein the respective sets of beam weight parameters for the set of communication beams comprises a respective beamforming weight in-phase value and a respective beamforming weight quadrature-phase value for each antenna of a set of antennas of the RU for each communication beam of the set of communication beams.

17. The method of claim 14, wherein:
the first message comprises a common header field that indicates a section type value associated with a beam weight update; and
the payload of the first message is based at least in part on the section type value being associated with the beam weight update.

18. The method of claim 14, wherein:
the first message comprises:
a common header field that indicates a section type value of 4 associated with a slot level configuration, and
a section type 4 command type field that indicates a beam weight update; and
the payload of the first message is based at least in part on the section type value of 4 being associated with the slot level configuration and the section type 4 command type field indicating the beam weight update.

19. The method of claim 14, wherein the payload comprises a first format type subsection that indicates:
a quantity of beams of the set of communication beams,
a beamforming weight compression parameter for the set of communication beams, and
a beam identifier indicating a first communication beam of the set of communication beams.

20. A non-transitory computer-readable medium storing code for wireless communications, the code comprising instructions executable by one or more processors to:
transmit, for a radio unit (RU), a first message that comprises a payload indicating:
respective sets of beam weight parameters for a set of communication beams, and
an acknowledgment request identifier; and
receive a second message that indicates successful or unsuccessful application of the respective sets of beam weight parameters for the set of communication beams at the RU based at least in part on the acknowledgment request identifier.
